(19) United States
(12) Patent Application Publication
(10) Pub. No.: US 2013/0187028 A1
(43) Pub. Date: Jul. 25, 2013

(54) IMAGERS HAVING VARIABLE GAIN AND RELATED STRUCTURES AND METHODS

(71) Applicants: Kenneth R. Salvestrini, Tucson, AZ (US); Hailing Guan, Oak Park, CA (US); Zhenwu Wang, Moorpark, CA (US); David Dozor, Tucson, AZ (US)

(72) Inventors: Kenneth R. Salvestrini, Tucson, AZ (US); Hailing Guan, Oak Park, CA (US); Zhenwu Wang, Moorpark, CA (US); David Dozor, Tucson, AZ (US)

(73) Assignee: Infrared Laboratories, Inc., Tucson, AZ (US)

(21) Appl. No.: 13/618,622

(22) Filed: Sep. 14, 2012

Related U.S. Application Data
(60) Provisional application No. 61/534,704, filed on Sep. 14, 2011.

(51) Int. Cl. H04N 5/378

(52) U.S. Cl. CPC H04N 5/378
USPC 250/208.1

(57) ABSTRACT

The present application relates to imagers having variable gain and related structures and methods. The gain of the imager may vary between rows of the imager. Such variability may be achieved by suitable design of a readout integrated circuit (ROIC). The ROIC may provide different integration period durations for different rows of the imager. Different integration capacitances may be provided for pixels of different rows of the imager. The gain of a column buffer may be varied when operating on output signals of pixels from different rows.

### RELATED APPLICATIONS

This application claims the benefit under 35 U.S.C. §119(e) of U.S. Provisional Application Ser. No. 61/534,704 filed Sep. 14, 2011 under Attorney Docket No. 10424.70001US00 and entitled “Imagers Having Variable Gain and Related Structures and Methods,” the entire contents of which is incorporated herein by reference.

### FEDERALLY SPONSORED RESEARCH

This invention was made with government support under Contract # W909MY-10-C-0044 awarded by the Department of Defense (Defense Contract Management Agency). The government has certain rights in the invention.

### BACKGROUND OF INVENTION

1. Field

The present application relates to imagers having variable gain and related structures and methods.

2. Related Art

Certain types of hyperspectral imagers include imaging rows which receive different wavelengths of radiation. Control over which wavelengths are directed to which rows of the imager is achieved with a grating or other dispersive element. FIG. 1 illustrates such an imager.

As shown, the conventional hyperspectral imager 100 includes an array 102 of imaging pixels 103 (typically photodetectors) arranged in rows 104 and columns 106. A diffraction grating 108 is also included, which has one or more slits 110.

When incident radiation 112 impinges on the diffraction grating 108, the slits 110 cause the radiation 112 to be split into different wavelengths that are spatially separated. For simplicity, three wavelengths λd-λ3 are shown in FIG. 1. As shown, the different wavelengths are directed toward different rows of the array.

For a given temperature of an object 114 being imaged, the different wavelengths λd-λ3 recorded by the hyperspectral imager will have different intensities, owing to principles of blackbody radiation. Therefore, because the different wavelengths are directed to different rows of the array 102, the power incident on the array 102 will vary between the rows (i.e., rows of the array receiving the first wavelength of radiation λ1 will receive a different intensity than will rows of the imager receiving the second wavelength of radiation λ2). In some instances, up to an order of magnitude difference in intensity may exist between radiation received by different rows.

### BRIEF SUMMARY

According to one aspect, a readout integrated circuit (ROIC) is provided, comprising a memory configured to store, for each of a plurality of temperatures, a plurality of integration period scaling factors including a first integration period scaling factor corresponding to at least one first row of an array of imaging pixels and a second integration period scaling factor corresponding to at least one second row of the array of imaging pixels. The ROIC further comprises a plurality of multipliers, each multiplier of the plurality of multipliers configured to: receive a nominal integration period value; receive one of the plurality of integration period scaling factors; and scale the nominal integration period value by the one of the plurality of integration period scaling factors to produce a corresponding scaled integration period value. The ROIC further comprises a plurality of pulse generators including one pulse generator corresponding to each row of the array of imaging pixels. Each of the plurality of pulse generators is configured to receive a scaled integration period value from a multiplier of the plurality of multipliers and generate one or more timing signals based on the received scaled integration period value. The one or more timing signals control, at least in part, a duration of an integration period of imaging pixels in a corresponding row of the array of imaging pixels.

According to another aspect, a readout integrated circuit (ROIC) is provided, comprising circuitry configured to provide an imaging array having multiple rows of imaging pixels with different gains for at least two rows of the multiple rows.

According to another aspect, a method of operating a readout integrated circuit (ROIC) is provided, the method comprising generating differences in gain between at least two different rows of an imaging array.

### BRIEF DESCRIPTION OF DRAWINGS

Various aspects and embodiments of the technology will be described with reference to the following figures. It should be appreciated that the figures are not necessarily drawn to scale. Items appearing in multiple ones of the figures are indicated by the same or a similar reference number in all the figures in which they appear.

FIG. 1 illustrates a conventional hyperspectral imager including an array of imaging pixels and a grating to direct different wavelengths of radiation to different rows of the array.

FIG. 2 is a block diagram of a non-limiting example of an imager including a detector array and a readout integrated circuit (ROIC), according to one embodiment.

FIG. 3 illustrates a non-limiting example of a detector array which may be used in combination with readout integrated circuits as described herein.

FIG. 4 is a block diagram of a ROIC suitable for implementing inter-row variable gain according to a non-limiting embodiment of the present application.

FIG. 5 is a detailed implementation of part of the ROIC of FIG. 4, according to one non-limiting embodiment.

FIG. 6 is a block diagram illustrating circuitry suitable for implementing different integration period durations between rows of an imaging array, according to one non-limiting embodiment.

FIG. 7 is a flowchart illustrating a method of generating timing signals for controlling integration of an imaging pixel, according to one non-limiting embodiment.

FIG. 8 illustrates a memory array and manner of writing data to the memory array, according to one non-limiting embodiment.

FIG. 9 illustrates the memory array of FIG. 8 and a manner of reading data from the memory array, according to one non-limiting embodiment.

FIGS. 10A and 10B illustrate timing signals for implementing different integration period durations between rows of an imaging array in snapshot mode and ripple mode, respectively, according to one non-limiting embodiment.

FIG. 11 illustrates a non-limiting detailed implementation of a pixel of the ROIC of FIG. 4, according to one non-limiting embodiment.

FIG. 12 illustrates a timing diagram of the operation of a readout integrated circuit which may be used with pixels of the type illustrated in FIG. 11, according to one non-limiting embodiment.

FIGS. 13A and 13B illustrate timing signals for implementing different integration period durations between rows of an imaging array of pixels of the type in FIG. 11 in snapshot mode and ripple mode, respectively, according to one non-limiting embodiment.

FIG. 14 illustrates a variation on the circuitry of FIG. 5 implementing variable integration capacitors, according to a non-limiting embodiment.

FIG. 15 illustrates a column buffer having an amplifier with variable gain that may be used to provide inter-row variable gain as described herein, according to one non-limiting embodiment.

FIG. 16 illustrates an example of a configuration of the amplifier of FIG. 15 in which the gain of the amplifier may be varied using feedback capacitors, according to a non-limiting embodiment.

FIG. 17 illustrates a non-limiting example of an imaging device comprising a photodetector array and a readout integrated circuit, according to one embodiment.

FIG. 18 illustrates a circuit for generating integration signals according to a non-limiting embodiment.

FIG. 19 is a flowchart illustrating a non-limiting embodiment of operation of a ROIC including the circuit 1800 of FIG. 18.

FIG. 20 illustrates the timing signal traces corresponding to operation of a ROIC of the type illustrated in FIG. 11 in accordance with the circuit 1800 of FIG. 18.

FIGS. 21A-21B illustrate, respectively, snapshot mode operation and ripple mode operation for a circuit operating on a single wavelength band, according to an embodiment of the present application.

FIGS. 22A-22B illustrate, respectively, snapshot mode operation and ripple mode operation for a circuit performing dual band operation, according to an embodiment of the present application.

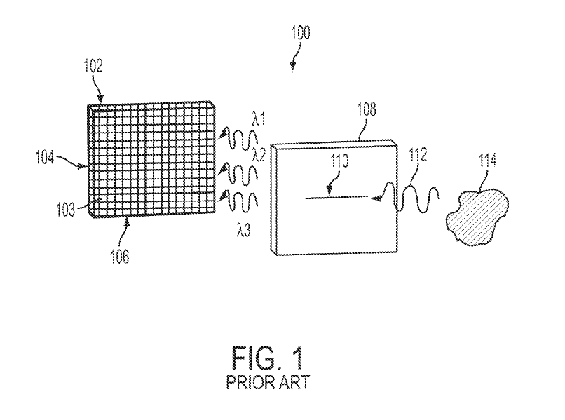

### DETAILED DESCRIPTION

Applicants have appreciated that the variability in intensity of received radiation between different rows of an imager may be problematic or simply undesirable in some operating scenarios. For example, such variability may produce shadows in a resulting image. Moreover, the full dynamic range of an imager may not be realized as a result of variations in intensity of radiation received by different rows of the imager.

Therefore, according to one aspect of the present application, imagers having variable gain between rows (which may be referred to herein as “inter-row variable gain”) are described, i.e., pixels in different rows of the imager may have different gains. In one embodiment, a row of pixels is a set of pixels that are addressed by a common clock signal but which output signals to different output lines (or busses). For example, two or more pixels may be addressed by receiving a common clock signal (e.g., a common transfer signal), but may provide their respective output signals to respective column lines.

In one embodiment, a row includes a linear arrangement of three or more pixels, with each of the three of more pixels being connected to respective column circuitry (e.g., respective column buffers or respective column switches) such that the output signal(s) of each pixel in the row is provided to respective column circuitry. As an example, three pixels may be arranged linearly and connected to a respective column line having a column buffer. Each of the three pixels may output a respective output signal to its respective column line.

In one embodiment, rows of an imager represent a “slow readout axis” of the imager whereas columns of the imager represent a “fast readout axis”, meaning that alternating between processing signals of pixels (e.g., processing output signals of the pixels) from one row and processing signals of pixels from another row is performed less frequently during operation of the imager than is alternating between processing signals of pixels from one column and processing signals of pixels from another column As a non-limiting example, first and second rows may each include 620 pixels. The first row of pixels may be selected and the output signals from those pixels may be read (or transferred) by sequentially selecting the 620 pixels of that row. Then, the second row of pixels may be selected and the output signals from those pixels may be read (or transferred) by sequentially selecting the 620 pixels of that row. In this manner, alternating between rows occurs more slowly than does alternating between columns (i.e., in this non-limiting example, 620 column transitions occur for each row transition).

Thus, it should be appreciated that, as used herein, the term “rows” is not limited to whether or not the pixels of the row are aligned horizontally or vertically or at any particular angle. Likewise, the language “inter-row variable gain” is not limited to any particular physical orientation, but again refers to differences in gain between pixels in different rows of an imager. The different gains may compensate for temperature induced differences in intensity of radiation impinging on the different rows of the imager or differences in target emissivity. However, the various aspects described herein are not limited to implementing or using variable gain between rows of an imager for any particular reason, as such aspects may be used for any reason.

According to one aspect, the variable gain functionality may be provided in the readout integrated circuit (ROIC) of an imager. The ROIC may be constructed and/or operated suitably to provide variable gain between the rows of the imager. For example, in a first non-limiting embodiment, the ROIC may implement (or cause to be implemented) different photocurrent integration period durations for at least two different rows. In another non-limiting embodiment, different integration capacitor sizes (i.e., different integration capacitances) may be implemented in pixels of different rows. In another non-limiting embodiment, the gain of a column buffer may be varied to have different values when receiving the output signals of pixels from different rows of the imager. Other techniques for providing variable gain between rows of an imager are also possible.

The aspects described above, as well as additional aspects, are described further below. These aspects may be used individually, all together, or in any combination of two or more, as the technology is not limited in this respect. Moreover, for purposes of explanation, much of the following discussion considers the context of hyperspectral imagers. However, it should be appreciated that at least some of the aspects described herein may apply to other types of imagers, and that hyperspectral imagers and imaging represent a non-limiting example.

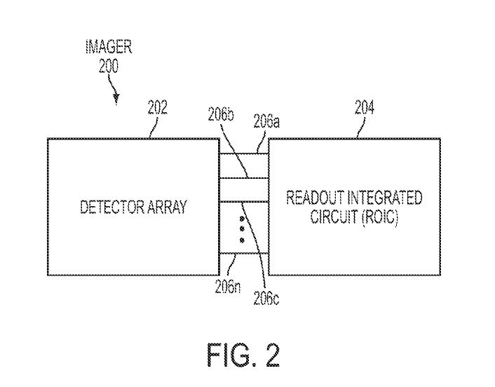

A non-limiting example of an imager to which various aspects of the present application may apply is illustrated in FIG. 2. As shown, the imager 200 includes a detector array 202 (e.g., a focal plane array or imaging array) and a read out integrated circuit (ROIC) 204. The detector array 202 and ROIC 204 may be connected to each other via connections 206a, 206b, 206c . . . 206n. The connections may be any suitable connections, such as wire bonding connections, bump bonds, or any other suitable interconnections. In some embodiments, the detector array 202 may be formed on a first substrate (for example, a first semiconductor substrate) while the ROIC 204 may be formed on a separate substrate. However, not all embodiments are limited in this respect. For example, in some embodiments the detector array and integrated circuit may be implemented on the same substrate. In some embodiments, the ROIC may be divided across two or more substrates. Thus, the various aspects described herein are not limited to forming the imager components on any particular number of substrates or in any particular physical relation relative to each other.

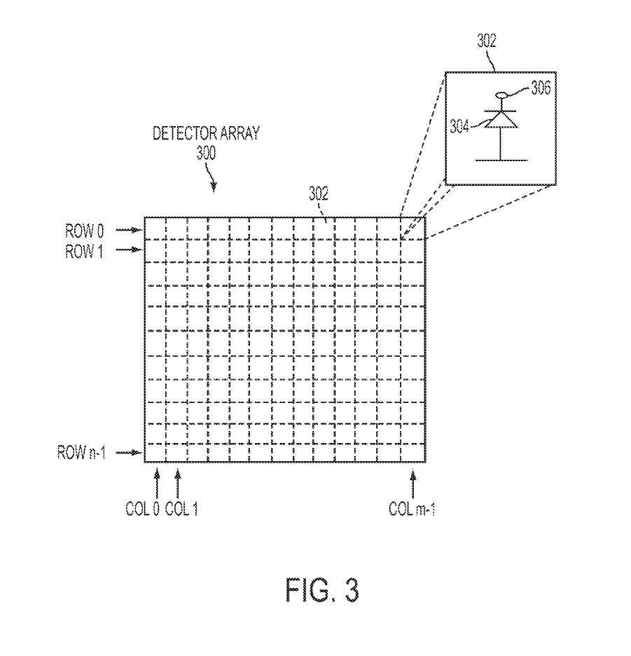

A non-limiting example of a suitable detector array 300 is illustrated in FIG. 3. The detector array 300 may be used as the detector array 202 in imager 200, though other types of detector arrays may alternatively be used. As shown, the detector array 300 includes a plurality of detectors 302 (also referred herein as detector units, pixels, or imaging pixels) arranged in an array of n rows and m columns As shown in the inset illustrating an enlarged view of a single detector 302, each detector may include a photodiode 304 (i.e., a photodetector), with an output node 306. Photodiode 304 may be suitable to detect any desired wavelength band. As a non-limiting example, photodiode 304 may be configured to detect medium wavelength infrared (MWIR) wavelengths. Alternatively, photodiode 304 may be configured to detect long wavelength infrared (LWIR) wavelengths. Detection of other wavelength bands with a photodiode 304 is also possible (e.g., visible, near infrared (NIR), very long wave infrared (VLWIR), some combination of any ones of those bands, some subset of any one of those bands, etc.). Thus, it should be appreciated that the various aspects described herein relating to imagers are not limited to the specific wavelengths detected unless otherwise stated.

Also, while photodiode 304 is illustrated as a non-limiting example, it should be appreciated that those of the aspects described herein relating to imagers having imaging arrays are not limited to the arrays implementing any particular type(s) of detector(s). Non-limiting examples of suitable detector types include pin-diodes (e.g., single diodes or in back-to-back format), though other types are also possible. The diodes may be mercury cadmium telluride (MCT) photodiodes, InAs/GaSb diodes, Quantum Well Infrared Photodiodes (QWIPs), or Type II Superlattice diodes, as non-limiting examples. Thus, in some non-limiting embodiments, third generation infrared detectors may be used, though not all embodiments are limited in this respect.

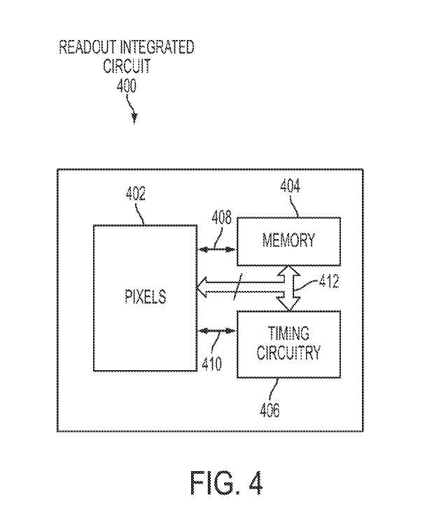

FIG. 4 is a block diagram of a non-limiting ROIC 400 according to an embodiment of the present application, and which may be used in the imager 200 and in connection with a detector of the type illustrated in FIG. 3. As shown, the ROIC 400 may include a plurality of pixels 402 (alternatively referred to herein as unit cells or ROIC cells), a memory 404, and timing circuitry 406, among other things. The pixels may represent circuitry of the ROIC dedicated to a particular detector of a photodetector array. Non-limiting examples are illustrated and discussed below. The timing circuitry 406 may be used to generate timing signals (also referred to herein as clock signals or control signals) for controlling the plurality of pixels 402. The memory 404 may store values used by the timing circuitry 406 to produce suitable timing signals. The memory 404 may also store any other suitable values used to control the plurality of pixels 402 or otherwise used in the operation of ROIC 400. The memory and timing circuitry may communicate with the pixels 402 in any suitable manner, for example, via bidirectional links 408 and 410. Additionally or alternatively, a data bus, such as data bus 412, of any suitable number of bits may be utilized.

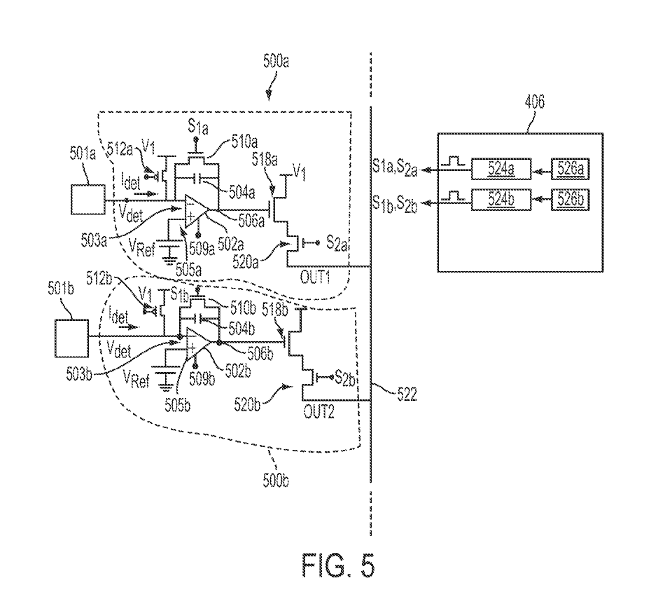

The pixels 402 may take any suitable form, as the various aspects described herein are not limited to ROICs implementing any particular type or configuration of pixels. Non-limiting examples of suitable types of pixels include direct injection (DI) pixels and capacitive transimpedance amplifier (CTIA) pixels. However, other suitable types of pixels include Buffered Direct Injection (BDI) pixels, Gain Modulation (GMI or GMOD) pixels, Time Delay and Integrate (TDI) pixels, source follower (SF) pixels, active pixels, and CMOS pixels, as non-limiting examples. The pixels may be configured to process signals relating to one or more wavelength bands. A non-limiting example of a suitable ROIC pixel type to which one or more aspects of the present application may apply is illustrated in FIG. 5.

FIG. 5 illustrates a non-limiting detailed implementation of part of the ROIC 400 of FIG. 4, including two pixels 500a and 500b and timing circuitry 406. The pixels 500a and 500b represent non-limiting examples of the pixels 402 of FIG. 4. The pixels 500a and 500b may correspond to different rows of an imager, for example with pixel 500a corresponding to an imaging pixel in a first row of an imager and pixel 500b corresponding to an imaging pixel in a second row of the imager. It should be appreciated that in practice there may be multiple ROIC pixels corresponding to an imager row, and that FIG. 5 illustrates only one pixel per row corresponding to two different rows for purposes of simplicity.

As shown, pixel 500a includes a single CTIA amplifier having an input coupled to detector 501a (e.g., detector 302 of FIG. 3) and an output configured to provide an output signal OUT1. The CTIA amplifier includes an operational amplifier 502a and a feedback capacitor 504a. The operational amplifier 502a may be coupled to (or couplable to) the detector 501a at one of its inputs, for example at the inverting input 503a of the operational amplifier, as shown. The connection may be a single electrical connection, for example formed by or including a wire bond, a single bump bond (e.g., an indium bump bond or any other suitable bump bond), or any other suitable interconnection. The second input 505a of the operational amplifier may be coupled to receive a reference voltage Vref, which may be any suitable reference voltage. As one specific non-limiting example, the global power supply voltage for the pixel 500a may be approximately 3.5 Volts and Vref may be selected to be approximately 1.3 Volts, between 1 Volt and 2 Volts, or any other suitable value, as the various embodiments are not limited in this respect. For instance, it should be appreciated that the voltages used may depend, at least partially, on the design rules used in designing the pixel, the fabrication process used in making the pixel, or other design/manufacturing considerations. Also, it should be appreciated that while a differential CTIA design is illustrated, a single-ended design may alternatively be used.

As shown in FIG. 5, the operational amplifier may also include a bias input 509a, though not all embodiments are limited in this respect. Any suitable bias value may be applied.

The feedback capacitor 504a may be any suitable type of capacitor and may have any suitable value. As discussed further below, in some embodiments the feedback capacitors of pixels corresponding to different rows of an imager may have different values. The feedback capacitor may function to integrate photocurrent from the detector 501a, thereby storing a photocharge. Thus, the feedback loop including the feedback capacitor 504a may be referred to as an integration loop.

A reset switch 510a (e.g., an n-channel metal oxide semiconductor field effect transistor (MOSFET)) may also be provided in parallel to the capacitive feedback loop. The reset switch may reset the feedback capacitor 504a when activated (closed). When activated, the reset switch may also set the voltage at the output 506a of amplifier 502a to the value of the reference voltage Vref (approximately 1.3 Volts, as a non-limiting example) by short circuiting the output 506a of the operational amplifier to the input 503a. The reset switch may be controlled by a signal S₁ₐ, which may be produced by timing circuitry 406. The reset switch 510a may be closed, for example, at the beginning or end of an integration period to reset the feedback capacitor (e.g., to clear integrated charge from the feedback capacitor 504a). However, not all embodiments are limited to having a reset switch 510a or using it in the manner described.

A switch 512a (e.g., a p-channel MOSFET) may also be provided to connect the input 503a of the operational amplifier to a bias voltage (e.g., a global supply voltage V₁, or any other suitable voltage). Such a switch may operate as a skimming circuit, for example to skim dark current from the ROIC pixel as needed. Accordingly, the switch 512a may be operated in any suitable manner to minimize (or reduce entirely) dark current from the pixel 500a. Other configurations for a skimming circuit may also be used, and in some embodiments a skimming circuit may not be included, as it is optional.

The pixel 500a may also include output circuitry, such as transistors 518a and 520a. As a non-limiting example, the output circuitry may include a source follower configuration, though not all embodiments are limited in this respect. The output circuitry may be coupled to the output 506a of the operational amplifier 502a and thus may provide an output signal OUT1 indicative of the voltage at the output 506a of the operational amplifier. Since the voltage at 506a may be indicative of the amount of radiation detected by detector 501a, the output signal OUT1 may likewise be indicative of the radiation detected by detector 501a. The output signal OUT1 may be provided to column circuitry (e.g., a column line or bus 522, a column buffer, etc.) connecting or multiplexing multiple pixels of the ROIC, or may be provided to any other suitable destination, as the various aspects described herein are not limited in this respect. As a non-limiting example, the source of transistor 520a may connect to the column bus 522.

The timing of when output signal OUT1 is provided to the column bus 522 may be controlled by timing signal S₂ₐ provided to the gate of transistor 520a. Signal S₂ₐ may be produced by the timing circuitry 406, as described below, or may be produced in any other suitable manner. The various aspects described herein are not limited in this manner.

The pixel 500b may be substantially the same as or identical to the pixel 500a, and may connect to a detector 501b similar to detector 501a. Thus, items 500b-520b and S_{1b}-S_{2b} are not described in detail owing to their similarity to items 500a-520a and S₁ₐ-S₂ₐ, respectively. Pixel 500b may generate an output signal OUT2.

As shown, the timing circuitry 406 may comprise circuitry suitable for generating timing signals to control operation of the pixels 500a and 500b. For example, the timing circuitry may include pulse generators, multipliers, or any other suitable circuitry. According to a non-limiting embodiment, the timing circuitry may include one pulse generator corresponding to each ROIC pixel of the ROIC.

In the non-limiting detailed implementation of FIG. 5, the timing circuitry 406 includes pulse generators 524a-524b and multipliers 526a-526b. The pulse generator 524a and multiplier 526a may operate in connection with pixel 500a, while the pulse generator 524b and multiplier 526b may operate in connection with pixel 500b. The pulse generator 524a may produce timing signals (e.g., timing signal S₁ₐ) to control integration by pixel 500a and readout of the output signal OUT1 to the column bus 522 (e.g., using timing signal S₂ₐ). Likewise, the pulse generator 524b may produce timing signals (e.g., timing signal S_{1b}) to control integration by pixel 500b and readout of the output signal OUT2 to the column bus 522 (e.g., using timing signal S_{2b}).

The timing signals S₁ₐ, S_{1b}, S₂ₐ, and S_{2b} may take any suitable form. According to a non-limiting embodiment, the timing signals may be digital signals, for example square wave pulses. Alternatives are possible.

As mentioned, according to one aspect of the present application, inter-row variable gain may be provided by implementing different integration period durations between rows of an imager. Using different integration period durations for different rows of an imaging array may effectively create different gains for the different rows. In this manner, naturally occurring variations of intensity between radiation impacting different rows may be compensated. However, it should be appreciated that the aspects described herein relating to implementing different integration period durations for different rows of an imager are not limited to doing so for any particular purpose. Moreover, it should be appreciated that the different integration period durations for different rows may be implemented within the same integration frame in some non-limiting embodiments.

The number of different integration period durations implemented for rows of an imager is not limiting. According to one embodiment, different integration period durations may be implemented for each row of the imager. For example, if an imager includes 480 rows (e.g., a 640×480 imager), 480 different integration period durations may be used in operating the imager during a frame; one integration period duration for each row. Alternatively, rows may be grouped, and a different integration period duration may be used for each group of rows. Again considering the example of an imager with 480 rows, the rows may be grouped into groups of five, and 96 different integration period durations may be used in operating the imager during a frame. For instance, rows 0-4 may utilize a first integration period duration, rows 5-9 may implement a second integration period duration, and so on. In those embodiments in which rows are grouped, any number of row groups may be implemented (e.g., the rows of the imager may be grouped into two or more groups). In some embodiments, the number of groups selected may correspond to an expected number of wavelength bands to be projected on an imaging array. For example, if a dispersive element (e.g., a grating) is used to separate incident radiation into X different wavelength bands projected to different portions of an imaging array, then X groups of rows may be formed, wherein X may have any value of two or more. However, alternative manners for determining a number of row groupings to use are also possible. Also, it should be appreciated that the aspects described herein relating to providing inter-row variable gain are not limited to use with imagers having any particular number of rows, and therefore a 480 row imager is merely a non-limiting example.

It should also be appreciated that, as used herein, providing different gains to different rows of an imager may comprise providing different gains to at least one pixel in at least two different rows (e.g., providing a first gain to a first pixel in a first row and a second gain different than the first gain to a first pixel in a second row). In some non-limiting embodiments, providing different gains to different rows of an imager may comprise providing all pixels in one row of the imager with different gains than that provided to all pixels in another row (e.g., all pixels of row 1 may have gain 1 while all pixels in row 2 may have gain 2, as a non-limiting example). Similarly, then, it should be appreciated that providing different integration period durations to different rows of an imager may comprise providing different integration period durations to at least one pixel in at least two different rows, and in some non-limiting embodiments may comprise providing all pixels in one row with different integration period durations than all pixels in another row (e.g., all pixels or row 1 may use the same first integration period duration while all pixels in row 2 may use the same second integration period duration different than the first integration period duration, as a non-limiting example).

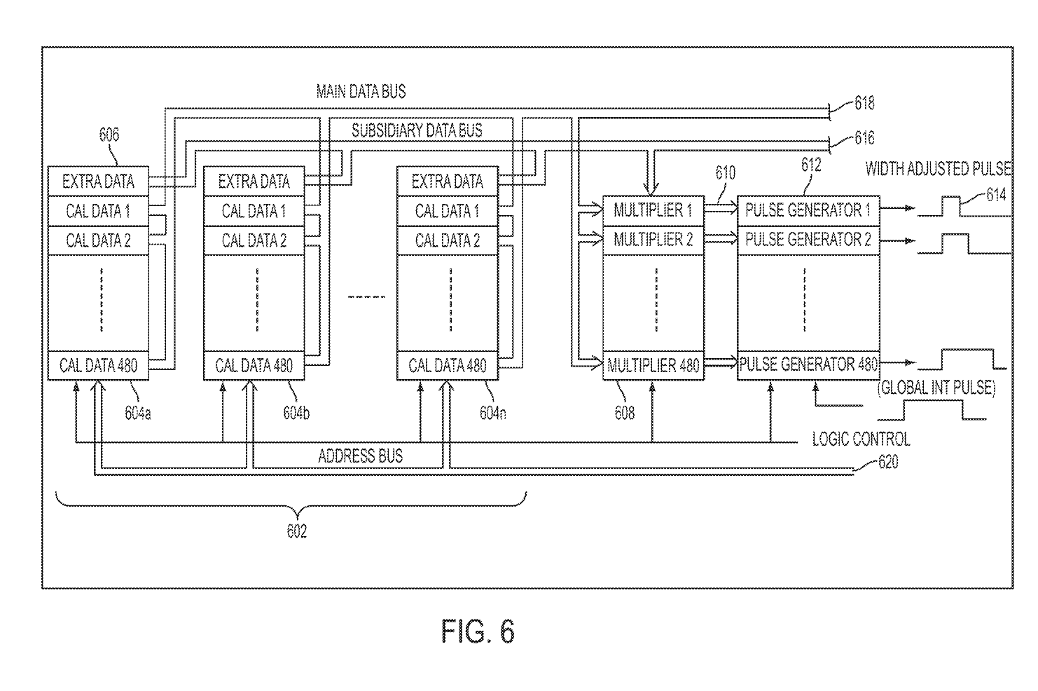

Implementation of different integration period durations for different rows of an imaging array may be accomplished in any suitable manner, and the various aspects described relating to providing different integration period durations for different rows are not limited in the manner of doing so. A non-limiting example is explained with respect to FIG. 6, though it should be appreciated that alternative implementations are possible.

FIG. 6 illustrates a portion of a ROIC according to an embodiment of the present application, including memory and timing circuitry. The timing circuitry may include pulse generators and multipliers, like the timing circuitry 406 shown in FIG. 5. However, the particular construction illustrated in FIG. 6 is non-limiting. The illustrated memory array 602 may be a portion of memory 404 of FIG. 4 or may be separate memory, as FIG. 6 is a non-limiting example. The multipliers may be part of the timing circuitry (e.g., as shown in FIG. 5), may be distinct from the timing circuitry in the ROIC, or may be related to the timing circuitry in any other suitable manner.

As shown, the memory may include a memory array 602 with multiple columns 604a-604n corresponding to different temperatures and multiple rows (or cells) 606. The rows 606 of the memory array 602 may store information which may be used to generate desired integration timing signals to control the integration period timing and duration of the rows (or groups of rows) of an imager.

In one embodiment, the memory array rows store calibration data (illustrated as “cal data”) or scaling factors for scaling the integration period duration of pixels of a corresponding row of an imaging array. The calibration data may be determined in any suitable manner. For example, in one non-limiting embodiment the calibration data may be determined by considering the blackbody radiation curve for a particular temperature. Based on the blackbody radiation curve, and an anticipated wavelength distribution across an imaging array (e.g., an anticipated assignment of certain wavelength bands to certain rows of an imager), the calibration data may be determined to provide a substantially uniform signal output level across the array despite differences in intensity due to blackbody principles. Alternatively, a gray body radiation curve may be used, rather than a blackbody radiation curve. As yet another alternative, some combination or weighting of a blackbody radiation curve and gray body radiation curve may be used. It should be appreciated, however, that the various aspects of the present application are not limited to determining the calibration data in any particular manner or to targeting any particular goal by using the calibration data (e.g., while uniform intensity across an imaging array may be targeted in some embodiments, not all embodiments are limited in this respect).

Thus, it should be appreciated that the calibration data may take any suitable values. For example, the calibration data may range between 0 and 2, between 0 and 1, or have any other suitable values. Thus, the various aspects are not limited in this respect.

Furthermore, the calibration data may be determined at any suitable time. For example, the calibration data may be determined prior to operation of the ROIC and may be provided to the ROIC by a user via a computer user interface. Alternatively, the calibration data may be determined dynamically or updated periodically. Alternatives are also possible.

As mentioned, the columns of the memory array may correspond to different temperatures. For instance, the first column may correspond to a first temperature, the second column to a second temperature, and so forth. Thus, the rows of the memory array may store calibration data for a corresponding temperature. For a given temperature (e.g., a detected environmental temperature, a pre-programmed temperature, etc.), the calibration data may be read out from the rows of the column corresponding to that temperature and provided to corresponding multipliers 608.

There may be one multiplier 608 corresponding to each of the rows 606 of the memory array, though not all embodiments are limited in this respect. In such an embodiment, each multiplier may receive a corresponding scaling factor (or calibration data) from a corresponding row of the selected memory column. The multiplier may also receive a nominal integration period value (i.e., a value indicating a nominal integration period duration, which may also be referred to herein as a nominal integration time), which it may then multiply by the received scaling factor. The output of the multiplier 610 may then be provided to a pulse generator 612, which subsequently produces a corresponding width adjusted pulse 614. The width adjusted pulse may represent a timing signal (e.g., timing signal S₁ₐ or timing signal S₂ₐ, as non-limiting examples).

The nominal integration period value may be provided to the multipliers 608 in any suitable manner. According to one embodiment, each column 604a-604n of the memory array includes a row storing extra data. The extra data may represent the nominal integration period value. Also, as will be discussed further below, one of the rows, or one of the groups of rows, may have the longest integration period duration of any of the rows or groups for that given temperature. The extra data may include an indication of which row/group has the longest integration period duration and/or an indication of the value of the longest integration period duration. The extra data may be programmed prior to operation of the ROIC (e.g., by a user via a user interface) or may be received in any other suitable manner. Upon selection of the calibration data from a particular column of the memory array, the extra data (and therefore the nominal integration period value, in this non-limiting embodiment) may also be selected and provided to the multiplier 608. However, it should be appreciated that the nominal integration period may be provided to the multipliers in any suitable manner.

The number of pulse generators 612 provided may correspond to the number of rows of an imaging array. For example, if an imaging array includes 480 rows, 480 pulse generators 612 may be provided, with each of the pulse generators producing the timing signals corresponding to a respective one of the rows of the imaging array. The number of multipliers 608 is not limited in this respect. Rather, the number of multipliers 608 may correspond to the number of row groupings of the rows of the imaging array. For example, if each row of a 480 row imager is to receive its own unique integration period duration, then 480 multipliers 608 may be included. However, if the rows are grouped together in two or more groupings for purposes of providing different integration period durations, the number of multipliers 608 may correspond to the number of groupings of rows. The number of groupings of rows may be selected to provide any desired granularity in the selection of integration period durations across the imaging array.

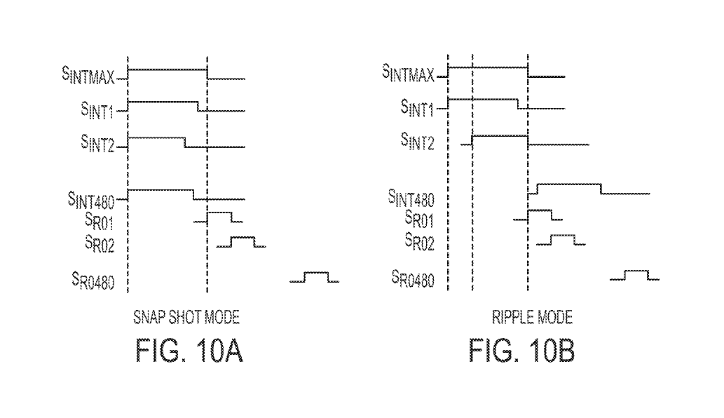

In addition to generating the integration signals, the pulse generators of FIG. 6 may generate transfer (or “readout”) signals for transferring the integrated charge from a pixel to column circuitry, such as a column buffer. Examples of such transfer or readout signals are shown and described in connection with FIGS. 10A and 10B. As explained in greater detail with respect to FIG. 10A, in some embodiments the transfer signals may not be started until the longest (or maximum) integration period for the imager has completed, such as when the imager is operated in snapshot mode. Thus, the maximum integration period may be provided to the pulse generators, as shown in FIG. 6 by the signal “Global Int Pulse”. The pulse generators may use the “Global Int Pulse” to properly time the transfer signals for reading integrated charge out of the pixels of the array.

Logic control, as illustrated, may be used to control, at least in part, which portions of the memory, multiplier circuit, and pulse generator column circuit are being used. The logic control may refer to clock signals used for such purposes, and the clock signals may take any suitable form.

Communication between the columns 604a-604n of the memory array 602 and the multipliers 608 may be accomplished in any suitable manner. According to one non-limiting embodiment, communication of the extra data, such as the nominal integration period value between the columns of the memory array and the multipliers may be performed via a subsidiary data bus 616. Communication between the columns of the memory array and the multipliers with respect to the scaling factors or calibration data for each row may be performed via a main data bus 618. However, it should be appreciated that alternatives are possible, and this is one non-limiting example. Data may be written to the memory array using the subsidiary data bus and the main data bus, or may be written and read in any other suitable manner.

A non-limiting example of calculation of integration period durations as may be performed using the circuitry of FIG. 6 is now provided for purposes of illustration. Assume that in the present example the relevant temperature is T and the relevant nominal integration period value is 100 mS. Knowing the temperature T, the circuit can locate the specific memory column which is associated with temperature T via the address bus 620. The calibration data in each row of the selected memory column is readout and is sent to the respective row of the multiplier column circuit. With the 100 mS nominal integration pulse and the calibration parameters, an integration pulse series which is row adjusted to compensate for the black body radiation variance across the different rows of the imaging array is generated for each row by the pulse generators and is sent to the pixel array to conduct the integration. The integration pulse series may be formed by, in some examples, multiplying the nominal integration pulse by the calibration parameters.

In addition, the last row of the selected memory column (the 481th row in this non-limiting example) is also read out to provide an indication of the row Rx which has the longest adjusted integration time. The pulse generators use such information about the longest adjusted integration time to generate the readout pulses (or transfer signals) after the longest integration time to assure that no conflict of integration and readout occurs.

It should be appreciated that in some embodiments the calibration data stored in the memory columns may represent values selected on the basis of an assumed nominal integration time which differs from an actual nominal integration time. As an example, the calibration data stored in the memory may be include values selected on the assumption that the nominal integration time is 1 second. If, in a particular application, the actual nominal integration time differs from the assumed nominal integration time (e.g., if the nominal integration time is 100 mS instead of 1 second), then it may be desirable in some scenarios to scale the calibration data itself. For example, if the calibration data is selected on the assumption that the nominal integration time will be 1 second but instead the nominal integration time is 100 mS, in some such embodiments the calibration data may itself be multiplied by a scaling factor k=0.1 to adjust the calibration data to account for the actual nominal integration time. However, such operation is a non-limiting example.

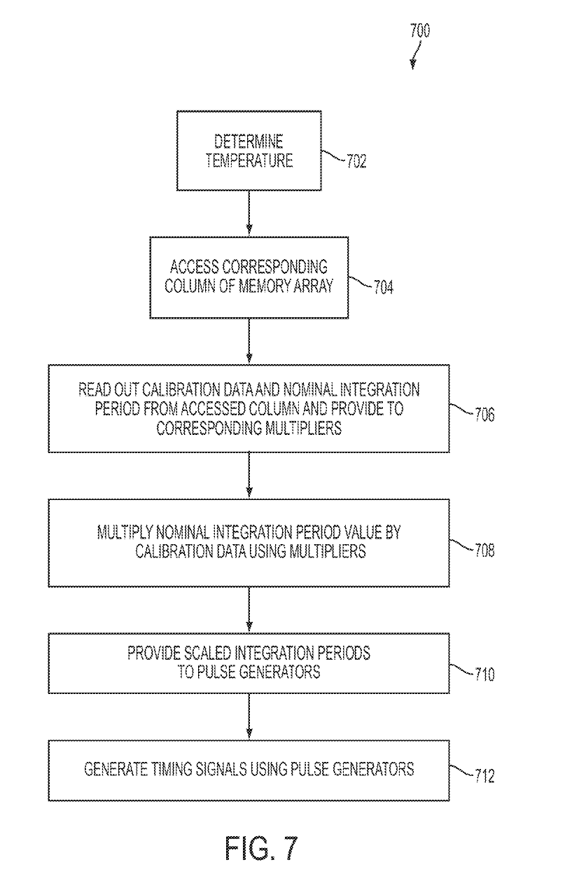

A non-limiting example of a manner of operation of the circuitry shown in FIG. 6 is now provided with respect to the flow chart of FIG. 7. As shown, the method 700 begins at 702 with determination of a temperature (in any suitable manner), such as the temperature of a scene to be imaged. Subsequently, using the determined temperature from step 702, the corresponding column 604a-604n of the memory array is addressed (or accessed) at 704 via an address bus 620. At 706, the extra data (e.g., the nominal integration period value) from the selected column as well as the calibration data of that column are provided to respective multipliers 608. At 708, the multipliers multiply the nominal integration period value by the received respective calibration data and provide the output 610 (e.g., a scaled integration period duration) to an appropriate pulse generator at 710. At 712, the pulse generators subsequently generate timing signals 614 which may be provided to ROIC pixels associated with a corresponding row of an imaging array, for example as illustrated in FIG. 5. Thus, suitably scaled timing signals may be provided to rows or groups of rows of an imager to provide different integration period durations to the pixels of those rows. In this manner, inter-row variable gain may be realized.

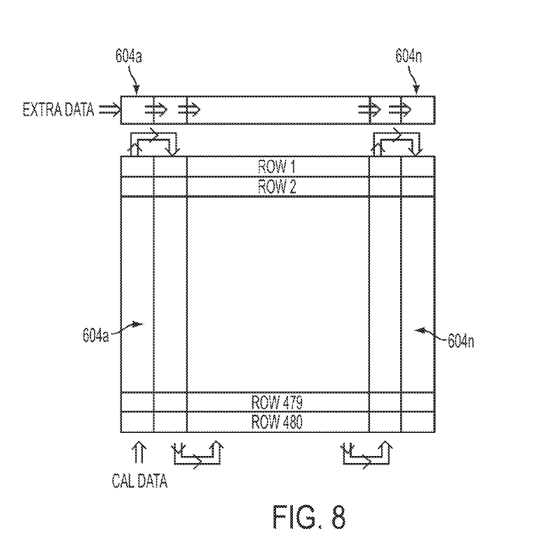

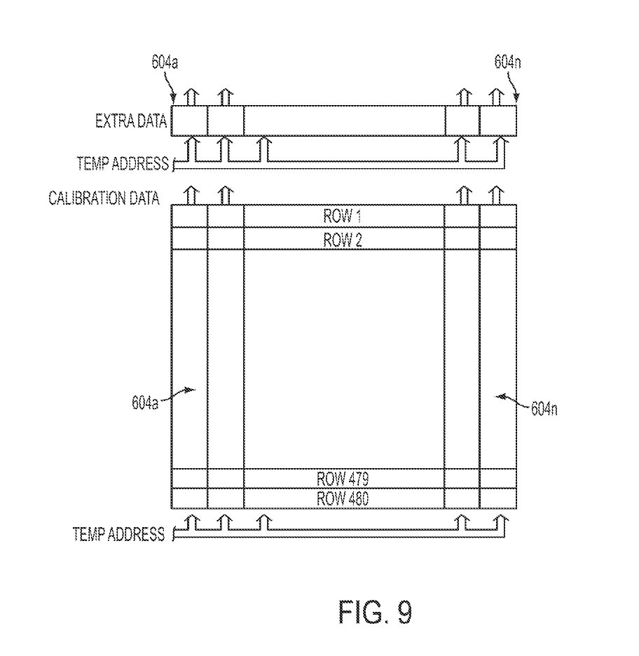

FIGS. 8 and 9 illustrate non-limiting examples of how data may be written to and read from the memory array 602. Referring to FIG. 8, which illustrates a write function, the calibration data (“cal data”) may be written serially as illustrated by the arrows, starting in this non-limiting example in the bottom left corner of the memory array, proceeding through all cells of the first column 604a before moving through the cells of the second column 604b and so on, until reaching the appropriate memory cell. The extra data may also be written serially, in this non-limiting embodiment from left to right of the extra data row, as illustrated.

FIG. 9 illustrates a read operation. As shown, for a selected column 604a-604n (addressed based on temperature with a value “temp address”), only one of which is turned on at a time in this non-limiting embodiment, the calibration data and extra data are read out sequentially beginning with the extra data and proceeding through the rows of the selected column.

FIGS. 10A and 10B illustrate non-limiting examples of timing signals which may result from operation of a ROIC as just described with respect to FIGS. 6-7. As a preliminary matter, it should be appreciated that an imager may be operated in various modes. One mode of operation may be snapshot mode, in which the integration of pixels in all rows begins at approximately the same time. Another mode of operation is ripple mode, in which the integration of pixels in different rows begins at different times (e.g., the integration of each row is delayed by one row time from the integration of the previous row). FIG. 10A illustrates non-limiting exemplary timing diagrams for operation of an imager in snapshot mode, while FIG. 10B illustrates non-limiting exemplary timing diagrams for operation of an imager in ripple mode. FIGS. 10A and 10B assume that the imager includes 480 rows, though it should be appreciated that not all embodiments are limited in this respect.

Referring to FIG. 10A, timing signals are illustrated for three of the 480 rows, namely rows 1, 2 and 480. The timing signals Sᵢₙₜ₁, Sᵢₙₜ₂, and Sᵢₙₜ₄₈₀ may represent the integration period durations corresponding to respective rows of an imaging array. Such integration period durations may be realized by generation of suitable timing signals provided to control pixels of a particular row. For example, suitable timing signals S₁ₐ and S_{1b} in FIG. 5 may be generated based on the integration period Sᵢₙₜ₁, as a non-limiting example. It can be appreciated from FIG. 10A that the duration of the pulses of signals Sᵢₙₜ₁, Sᵢₙₜ₂₉ and Sᵢₙₜ₄₈₀ differs, as may result, for example, from application of different scaling factors associated with rows 1, 2, and 480 to a nominal integration period value.

It should also be appreciated that operation of a ROIC in the manner previously described may result in one row (or a group of rows) having the longest integration duration, which may be referred to as the maximum integration period duration. FIG. 10A illustrates a timing signal corresponding to the maximum integration period duration (Sᵢₙₜₘₐₓ).

FIG. 10 also illustrates the timing of read out of rows corresponding to the integration periods illustrated. Namely, a read out signal (or transfer signal) for pixels in row 1 is represented by S_{RO1}, which may correspond, for example, to S₂ₐ in FIG. 5. A read out signal for pixels in row 2 is represented by S_{RO2}, which may correspond, for example, to S_{2b} in FIG. 5. A read out signal for pixels in row 480 is represented by S_{RO480}. As mentioned in connection with FIG. 6, the readout or transfer signals may be generated by the pulse generator for the corresponding row. As shown in FIG. 10A, in snapshot mode read out of any of the rows is delayed until the maximum integration period is complete. Thus, information relating to the maximum integration period (e.g., the duration of the period and/or the row/rows exhibiting the maximum duration) may be included in the extra data and provided to the pulse generators in FIG. 6, such that the pulse generators may suitably time read out of the corresponding rows.

Referring to FIG. 10B, a ripple mode of operation is illustrated. In contrast to snapshot mode, in ripple mode read out of pixels from one row is not delayed until integration of all rows is complete. Rather, read out of some rows may occur in parallel to integration of other rows of the imager. The timing illustrated is a non-limiting example, as alternatives are possible.

It should be appreciated that use of one or more of the previously described aspects may allow for generation of integration period durations which vary between rows (or groups of rows) of an imager. In one embodiment, the integration period duration applied to a row, or group of rows, of an imager may remain substantially constant throughout operation of the imager. For example, based on a temperature of operation, the integration period duration for a given row may be set at the beginning of operation of the imager and may not be changed. Alternatively, the integration period durations of rows may be dynamically varied during operation of an imager. For example, the integration period durations assigned to rows, or groups of rows, of the imager may vary with variations in temperature. As differences in temperature are detected, the memory array of FIG. 6 may be accessed and the timing signals updated accordingly. In this manner, operation of imager may dynamically account for changes in operating environment, among other things.

It should be appreciated that the memory array 602 may be considered a lookup table, and thus according to one embodiment different integration period durations are provided to different rows of an imaging array using a lookup table. In the non-limiting example, the memory array 602 may be a 50×481 memory array. Each of the fifty columns may correspond to a respective temperature. Each of the fifty columns may include 481 memory cells; 480 of the 481 memory cells storing information regarding integration period scaling factors (calibration data Cal Data 1-Cal Data 480) for the respective 480 rows of a 480-row imager, and one memory cell storing miscellaneous, or extra data. Thus, in this non-limiting example, the ROIC may provide suitable compensation for at least fifty temperatures.

Some of the foregoing discussion has been provided in the context of a ROIC configured to operate with a single wavelength band detection imager, meaning that the pixels of the imager receive and process signals relating to a single wavelength band. In particular, pixels 500a and 500b are configured to operate on signals from detectors 501a and 501b representative of a single detected wavelength band. However, it should be appreciated that the various aspects described herein are not limited in this respect. For example, dual-band and multiband (e.g., hyperspectral or multispectral) imagers may utilize one or more aspects described herein. A non-limiting example is the implementation of inter-row variable gain within a dual-band imager, an example of which is now provided, though it should be appreciated that alternative implementations to those now discussed are possible.

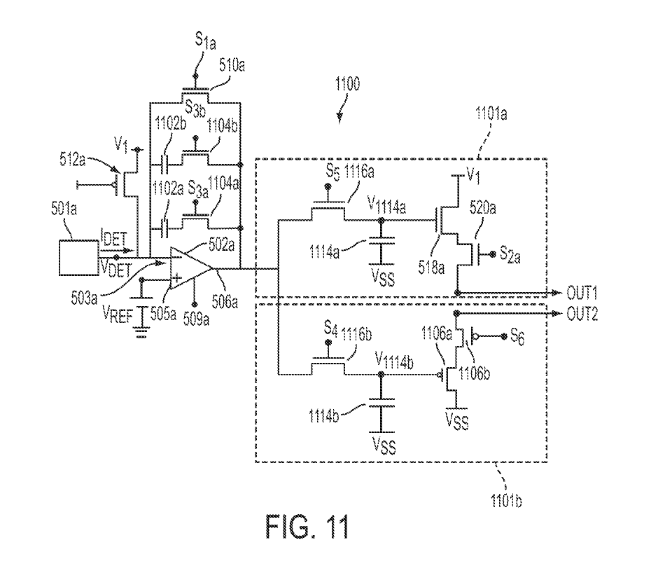

FIG. 11 illustrates a ROIC pixel 1100 representing an alternative to the pixel 500a, according to a non-limiting embodiment. The ROIC pixel 1100 is similar in some respects to pixel 500a, but is configured to process signals from a detector relating to two different wavelength bands (e.g., detector 501a in this non-limiting example may detect two different wavelength bands of radiation and provide an output signal accordingly). Thus, the ROIC pixel 1100 may be implemented as part of a dual band imager, as a non-limiting example. Those components in the pixel 1100 previously described in connection with FIG. 5 are not described in detail here.

In contrast to pixel 500a, the CTIA amplifier of pixel 1100 includes multiple feedback capacitors arranged in multiple feedback loops. In the non-limiting example shown, two capacitive feedback loops (also referred to herein as integration loops since they may be used to integrate photocurrent) are shown. The first includes feedback capacitor 1102a and switch 1104a, while the second includes feedback capacitor 1102b and switch 1104b. The switches 1104a and 1104b may be MOSFET switches (e.g., n-channel MOSFETS), or any other suitable switches, and may be used to selectively close the capacitive feedback loops. Timing signals S₃ₐ and S_{3b} may be used to control operation of the switches 1104a and 1104b, respectively.

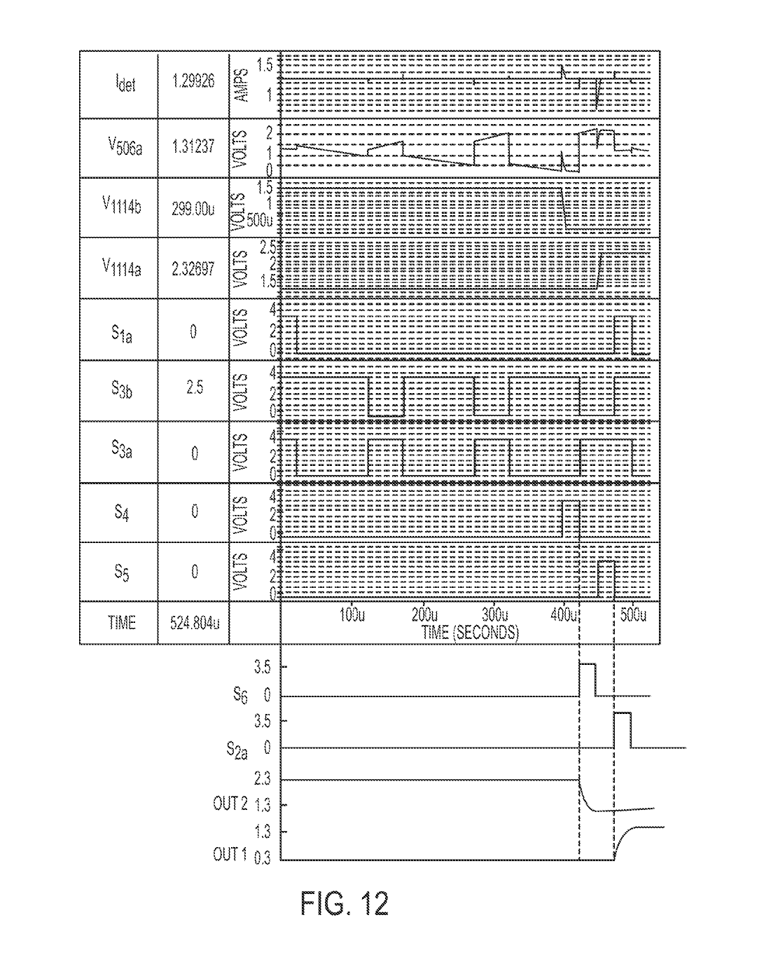

The two capacitive feedback loops may be configured to integrate photocurrent relating to the two wavelength bands detected by detector 501a in this non-limiting example. For example, the loop including capacitor 1102a may be used to integrate photocurrent relating to a first wavelength band while the loop including capacitor 1102b may be used to integrate photocurrent relating to a second wavelength band. Thus, by suitably switching between the capacitive feedback loops (with timing signals S₃ₐ and S_{3b}), separate integration of photocurrent relating to the two wavelength bands detected may be achieved. A non-limiting example of the operation is described further below in connection with FIG. 12.

The pixel 1100 also includes two processing channels 1101a and 1101b; one processing channel for each of the wavelength bands detected by detector 501a. The processing channels 1101a and 1101b may be used to sample and/or store and/or output charge indicative of an amount of radiation detected by the detector 501a in a corresponding wavelength band. As a non-limiting example, assuming that the detector 501a detects radiation in the MWIR and LWIR bands (e.g., by using photodiodes specific to each band), the processing channel 1101a may be configured to sample a voltage from the operational amplifier 502a indicative of detected radiation in the LWIR band, while the processing channel 1101b may be configured to sample a voltage from the operational amplifier 502a indicative of detected radiation in the MWIR band. The processing channels may then also output signals OUT1 and OUT2, respectively, indicative of the sampled voltages, and therefore indicative of the detected radiation in the respective bands. Accordingly, the processing channels 1101a and 1101b may be considered output channels. The processing channels may have any suitable configuration(s) for performing the described functions (e.g., sampling and/or storing and/or outputting signals), and the sample and hold configurations shown in FIG. 11 are non-limiting.

In greater detail, the processing channel 1101a may include a sample and hold capacitor 1114a (or, more generally, a storage capacitor) switchably coupled to the output 506a of the operational amplifier via a switch 1116a (e.g., an n-channel MOSFET), which itself may be controlled by a signal S₅. One end of the sample and hold capacitor may be coupled to a supply rail or voltage (e.g., a global supply voltage) Vss. The sample and hold configuration may facilitate operation of the ROIC in snapshot mode, though the various aspects described herein are not limited to snapshot mode (e.g., ripple mode may be used, as an example).

The processing channel 1101a may also include output circuitry, such as transistors 518a and 520a, previously described in connection with FIG. 5. The output circuitry may be coupled to the sample and hold capacitor 1114a and configured in any suitable manner to provide an output signal OUT1 indicative of the charge stored on the sample and hold capacitor 1114a, and therefore indicative of the radiation detected by detector 501a in a particular wavelength band. The output signal OUT1 may be provided to column circuitry (e.g., a column line or bus, a column buffer, etc.) connecting multiple pixels of the ROIC (e.g., as previously discussed in connection with FIG. 5), or may be provided to any other suitable destination, as the various aspects described herein are not limited in this respect. As a non-limiting example, the source of transistor 520a may connect to a column bus.

The processing channel 1101b may be similar in design to the processing channel 1101a. In some embodiments, the processing channels 1101a and 1101b may be substantially the same in design, or identical. For example, as shown, the processing channel 1101b includes a sample and hold capacitor 1114b (or, more generally, a storage capacitor) switchably coupled to the output 506a of the operational amplifier 502a via a switch 1116b (e.g., an n-channel MOSFET), which itself may be controlled by a signal S₄. The sample and hold configuration may facilitate operation of the ROIC in snapshot mode, though the various aspects described herein are not limited to snapshot mode.

The processing channel 1101b may also include output circuitry, such as transistors 1106a (e.g., a p-channel MOSFET) and 1106b (e.g., a p-channel MOSFET). As a non-limiting example, the output circuitry may include a source follower configuration, though not all embodiments are limited in this respect. The output circuitry may be coupled to the sample and hold capacitor 1114b and configured in any suitable manner to provide an output signal OUT2 indicative of the charge stored on the sample and hold capacitor 1114b and therefore indicative of the radiation detected by detector 501a in a particular wavelength band. The output signal OUT2 may be provided to column circuitry (e.g., a column line or bus, a column buffer, etc.) connecting multiple pixels of the ROIC, or may be provided to any other suitable destination, as the various aspects described herein are not limited in this respect. As a non-limiting example, the source of transistor 1106b may connect to a column bus.

Again, the configuration of FIG. 11 is a non-limiting example of a suitable configuration of a ROIC pixel for connecting to a detector 501a via a single connection and processing signals from the detector 501a corresponding to multiple (e.g., two) wavelength bands. Alternative configurations are possible, including alternative ordering of components and use of alternative components. As a non-limiting example, the pixel 1100 may connect to an imaging array via a dual bump connection (e.g., one connection for each wavelength band detected), or via any other suitable interconnection scheme.

Moreover, the various components illustrated in FIG. 11 may have any suitable values. For example, the capacitors (i.e., the feedback capacitors and sample and hold capacitors) may have any suitable capacitances to provide suitable operation in terms of integrating photocurrent from a detector 501a. In some embodiments, the values of the capacitances may be selected based on, for example, current magnitudes expected to be generated by the detector 501a in response to receiving incident radiation, which in turn may be dependent on expected flux densities of the wavelength bands. In some embodiments, the feedback capacitances may differ in value, though not all embodiments are limited in this respect. As a non-limiting example, a 5:1 ratio between the capacitance value of capacitor 1102a and the capacitance value of capacitor 1102b may be implemented (e.g., capacitor 1102a may be approximately 100 femtoFarads while capacitor 1102b may be approximately 20 femtoFarads). Such a ratio may be appropriate when, for example, capacitor 1102a is intended to integrate charge corresponding to detection of LWIR radiation and capacitor 1102b is intended to integrate charge corresponding to detection of MWIR radiation. Non-limiting alternative ratios between the capacitance of 1102a and the capacitance of 1102b may include 4:1, 3:1, and 2:1. These, however, are non-limiting examples, and it should be appreciated that suitable ratios and suitable absolute capacitance values may be selected depending on expected intensity differences between the different wavelength bands to be detected.

Likewise, the capacitors 1114a and 1114b may have any suitable values, including the same value as each other or different values. According to one non-limiting embodiment, both capacitors 1114a and 1114b may be approximately 0.25 picoFarads (pF), though alternative values are possible.

It should also be appreciated that while various switches in FIG. 11 are illustrated as FETs, the embodiments described herein including switches are not limited to use of any particular type of switch. For example, other types of transistors may be used (e.g., junction field effect transistors (JFETs), bipolar junction transistors (BJTs)), or other types of switches. Furthermore, in those embodiments in which FETs are used as switches, the FETs may be any suitable type of FETs and may have any suitable polarity (n-type, p-type, etc.).

The switches may be controlled by any suitable timing signals S (also referred to herein as control signals or clock signals), examples of which are discussed below in connection with FIG. 12. The timing signals may be generated by any suitable signal generation circuitry, such as, for example, timing circuitry 406 of FIG. 4.

It should also be appreciated that the configuration of FIG. 11 represents a non-limiting example of a pixel of a ROIC in which multiple processing channels (e.g., processing channels 1101a and 1101b) share an amplifier. Such a configuration may result in substantial space savings in the physical implementation of the pixel 1100 (e.g., when implemented on a semiconductor substrate) compared to providing dedicated amplifiers for each processing channel.

Furthermore, it should be appreciated that, according to one aspect, a CTIA amplifier of a ROIC pixel includes one or more feedback capacitors corresponding to each of the processing channels and/or to each of the wavelength bands detected by the detector. Thus, FIG. 11 illustrates a non-limiting example in which the CTIA amplifier includes two feedback capacitors to accommodate the two wavelength bands detected by the detector 501a.

Moreover, it should be appreciated that FIG. 11 illustrates a non-limiting example in which a single electrical connection is used to connect the ROIC pixel to the detector even though the detector may have multiple photodetectors for detecting different wavelength bands. Alternative configurations and manners for connecting a ROIC to a detector are possible.

For completeness, it should be appreciated that the feedback capacitors 1102a and 1102b may be considered to be part of separate channels of the ROIC pixel 1100 (e.g., the feedback capacitor 1102a may be considered part of the processing channel 1101a and the feedback capacitor 1102b may be considered part of the processing channel 1101b). Thus, for instance, the pixel 1100 may be described as including one channel comprising the feedback loop of capacitor 1102a and switch 1104a together with the processing channel 1101a. Similarly, the pixel 1100 may be considered to include a second channel comprising the feedback loop of capacitor 1102b and switch 1104b together with the processing channel 1101b. In such scenarios, the operational amplifier may be considered to be part of both channels or neither channel, and the various embodiments described herein are not limited in this respect.

A non-limiting example of operation of the pixel 1100 of FIG. 11 will now be described. Because various components of the pixel 1100 intended for use in processing different wavelength bands share an amplifier, and therefore access to the detector 501a, Applicants have appreciated that a suitable manner of operating a ROIC pixel of the type illustrated in FIG. 11 may involve time division multiplexing, or other suitable timing sharing schemes.

According to one aspect of the present application, time sharing of a CTIA amplifier is used to selectively integrate photocurrent corresponding to different wavelength bands on different capacitors of a ROIC pixel. Referring to FIG. 11, for example, photocurrent from the detector 501a may be selectively integrated onto feedback capacitors 1102a and 1102b such that those capacitors store voltages indicative of first and second wavelength bands detected by the detector 501a, respectively. As a non-limiting example, the detector 501a may include back-to-back photodiodes which detect radiation in first and second wavelength bands, respectively. The output current I_{da} (and corresponding voltage V_{det}) from detector 501a may at one time represent detection of the first wavelength band (e.g., when the photodiode corresponding to the first wavelength band is suitably biased) while at another time may represent detection of the second wavelength band (e.g., when the photodiode corresponding to the second wavelength band is suitably biased). Thus, for example, the capacitor 1102a may be selected to integrate photocurrent from detector 501a when the photocurrent corresponds to detection of the first wavelength band, while the capacitor 1102b may be selected to integrate the photocurrent when the photocurrent corresponds to detection of the second wavelength band. Suitable synchronization between selection of the capacitors 1102a and 1102b and the biasing of photodiodes in detector 501a (for example, if the detector 501a includes back-to-back photodiodes) may be used to perform selective integration of photocurrent corresponding to different wavelength bands. Suitable sampling of the voltage V₅₀₆ₐ at the output 506a of operational amplifier 502a may then be performed to store charge on capacitors 1114a and 1114b corresponding to the respective wavelength bands.

In some scenarios, temporal correlation between detection of different wavelength bands may be desired, such that images produced for the different wavelength bands may accurately reflect the same time, as closely as possible. Because time sharing of the CTIA amplifier of FIG. 11 is used, some temporal mismatch between wavelength bands may occur. Applicants have appreciated that the mismatch may be minimized, and therefore the temporal correlation improved, by alternately integrating photocurrent corresponding to the different wavelength bands detected during a single integration period. In this sense, detection of one wavelength band may be temporally “interleaved” with detection of another band. A non-limiting example is now described with respect to FIG. 12.

FIG. 12 illustrates signal traces corresponding to one manner of operation of a ROIC of the type illustrated in FIG. 11. Traces are shown for the current output I_{det} of detector 501a (in Amps), the voltage V₅₀₆ₐ at the output 506a of operational amplifier 502a, the voltages V₁₁₁₄ₐ and V_{1114b} of capacitors 1114a and 1114b, respectively, the timing signals S₁ₐ, S₂ₐ, S₃ₐ, S_{1b}, S₄, S₅, and S₆ supplied to various ones of the switches as shown in FIG. 11, and the signals OUT1 and OUT2 of FIG. 11. All voltages in FIG. 12 are in Volts. The behavior illustrated is for a single integration period of approximately 500 microseconds. It should be appreciated, however, that other time durations are possible and that the illustrated timing is a non-limiting example.

At the beginning of the illustrated integration period, signal S₁ₐ, which is provided to the reset switch 510a, is high, thus resetting the voltage V₅₀₆ₐ to its default value approximately equal to the value of V_{ref}. As mentioned previously, a non-limiting example of the value of V_{ref} is 1.3 Volts, such that at the beginning of the timing diagram of FIG. 12 the value of V₅₀₆ₐ is approximately 1.3 Volts. The illustrated reset action may correspond to the beginning of a new integration period in which previously stored charge is cleared from the circuit.

Subsequently, the reset switch 510a is turned off (when S₁ₐ goes low, at approximately 25 microseconds) and integration of photocurrent I_{det} begins. As shown, between the end of the reset action (at approximately 25 microseconds) and approximately 400 microseconds, the polarities of signals S₃ₐ and S_{3b} alternate. Correspondingly, the states of switches 1104a and 1104b alternate, and thus the photocurrent I_{det} is alternately integrated on feedback capacitors 1102a and 1102b. More specifically, the photocurrent I_{det} is integrated on capacitor 1102a while S₃ₐ is high and is integrated on capacitor 1102b while S₃₆ is high. The corresponding voltage behavior at the output 506a of operational amplifier 502a can be seen from the trace of V₅₀₆ₐ.

After integration of the photocurrent has proceeded in the described manner for a suitable (or desired) amount of time, the voltages stored on capacitors 1102a and 1102b are sampled by channels 1101a and 1101b. More specifically, in the non-limiting example shown, switch 1116b is turned on at approximately 400 microseconds by sending S₄ high, thus sampling the voltage V₅₀₆ₐ at that time onto the sample and hold capacitor 1114b. The voltage V₅₀₆ₐ at that time corresponds to the voltage on feedback capacitor 1102b since S₃₆ is also high at that time. The resulting change in the voltage V_{1114b} of capacitor 1114b can be seen in FIG. 12 at approximately 400 microseconds. Switch 1116b is then closed by sending S₄ low and subsequently, at approximately 450 microseconds, switch 1116a is turned on by sending S₅ high, thus sampling the voltage V₅₀₆ₐ at that time onto the sample and hold capacitor 1114a. The voltage V₅₀₆ₐ at that time corresponds to the voltage on feedback capacitor 1102a since S₃ₐ is also high at that time. The resulting change in voltage V₁₁₁₄ₐ of capacitor 1114a can be seen in FIG. 12 at approximately 450 microseconds.

The output signals OUT1 and OUT2 may then be read out to column circuitry, as a non-limiting example, in response to readout signals (or transfer signals) S₆ and S₂ₐ, respectively, shown as assuming a high value at approximately 425 microseconds and 475 microseconds, respectively.

Subsequently, the pixel may be reset by sending S₁ₐ high at approximately 475 microseconds to begin new integration period.

As should be appreciated from the foregoing discussion, operation of the pixel 1100 in the manner illustrated in FIG. 12 may be used to sample and store charge separately on capacitors 1114a and 1114b corresponding to different wavelength bands detected by the detector 501a. Thus, the operation may be used for a dual band imager.

Various features of the illustrated timing diagrams are worthy of further discussion. For instance, as mentioned, the actual timing illustrated is non-limiting. For example, while the integration period shown is approximately 500 microseconds in duration, that period may have any suitable value (e.g., between 500 microseconds and 1000 microseconds, between 200-600 microseconds, or any other suitable duration).

Furthermore, any suitable number and duration of alternating periods between integration on capacitors 1102a and 1102b (via alternating polarities of the signals S₃ₐ and S_{3b}) may be implemented. FIG. 12 illustrates the non-limiting example of three alternating periods, i.e., photocurrent is separately integrated three times (i.e., during three time periods (alternatively referred to as time intervals, or integration intervals)) on each of capacitors 1102a and 1102b between reset of the pixel and sampling of the voltage V₅₀₆ₐ. More or fewer alternating periods may be employed. For a given total integration period, the greater the number of alternating periods employed, the greater the temporal correlation between detection of the different wavelength bands.

The duration of the alternating periods may also take any suitable value(s). In some embodiments, the alternating periods (or time intervals) may be of approximately equal value, such that integration occurs on capacitors 1102a and 1102b for approximately equal durations. Alternatively, the alternating periods may have different values, such that, for example, integration on one of the feedback capacitors occurs for longer than does integration on the other of the feedback capacitors. In the non-limiting example of FIG. 12, signal S_{3b} is high for a greater duration than is signal S₃ₐ, meaning that integration on capacitor 1102b is performed for a longer time than is integration on capacitor 1102a. Such a difference in integration times may be selected for any reason, for instance to account for expected differences in flux levels between the different wavelength bands detected, or for any other reason. Accordingly, the amount of difference between the integration times of the different feedback capacitors may be selected to take any suitable values. In the non-limiting example of FIG. 12, signal S_{3b} is high for approximately 300 microseconds of the 500 microsecond integration period, while S₃ₐ is high for approximately 150 microseconds. Again, those durations are non-limiting. Using such values, images produced corresponding to the different wavelength bands may be synchronized within approximately 100 microseconds, or less, of each other.

It should be appreciated that the above-described operation of a ROIC pixel may be utilized in a snapshot mode of an imager, or in any other suitable mode. Thus, the various aspects described herein are not limited to any particular mode of operation of an imager.

Aspects of the present application relating to provision of inter-row variable gain may be applied to a dual band imager operating in the manner described with respect to FIG. 12. It should be appreciated that the different wave length bands detected by a single pixel may have different intensities owing to black body radiation effects, or for any other reason. Thus, while the previously described example of inter-row variable gain for a single band imager using the circuitry of FIG. 6 included a single calibration factor for each row, or group of rows, of an imager to be compensated, it should be appreciated that two values per row or group of rows may be provided when providing inter-row variable gain to a dual band imager having ROIC pixels of the type illustrated in FIG. 11. In this manner, suitable compensation with respect to the integration periods of both wave length bands detected may be achieved.

However, the circuitry required to process two calibration factors per ROIC pixel to provide inter-row variable gain may be undesirably complicated in some scenarios. Thus, a relatively more simplistic implementation may utilize the construction of the memory array illustrated in FIG. 6 and provide a single calibration factor for each row, or group of rows, of the imager to be compensated. Selection of the calibration factor may be made in any suitable manner, and in some embodiments may be made to represent an average of a calibration factor that would be appropriate for the first wave length band detected by the dual band imager and a calibration factor that would be appropriate for a second wave length band detected by the dual band imager. As a non-limiting example, if a suitable calibration factor for a given row of an imager for a first wave length band detected by pixels of that row is 0.4, and if a suitable calibration factor for a second wave length band of that row is 0.5, in some non-limiting embodiments, the average (i.e., 0.45) may be utilized as the calibration factor for calibrating the integration period duration for an imaging pixel in that row.

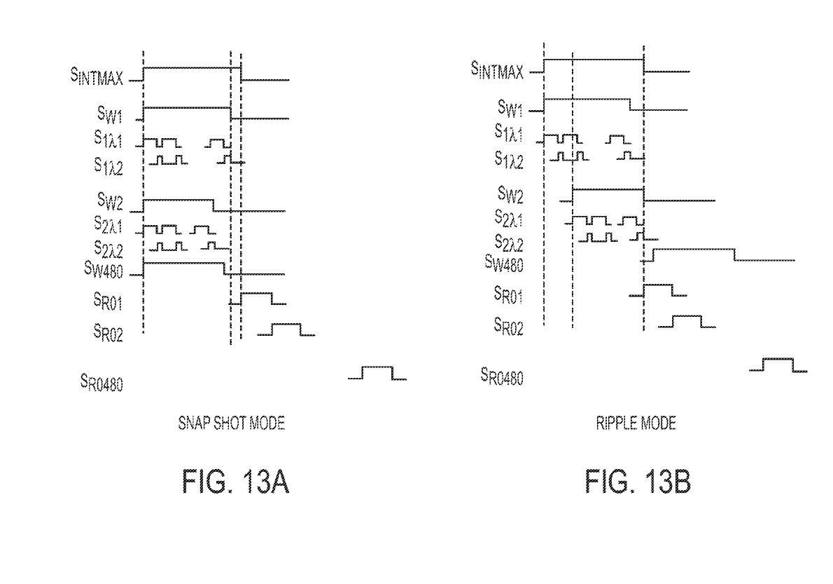

FIGS. 13A and 13B illustrate non-limiting examples of timing diagrams corresponding to provision of inter-row variable gain between rows of a dual band imager in which a single calibration factor is used per row of the imaging array. FIG. 13A illustrates timing diagrams for operation of the dual band imager and snapshot mode, while FIG. 13B illustrates timing diagrams for operation in ripple mode.

With respect to FIG. 13A, timing diagrams for two rows (rows 1 and 2) of an imager are illustrated. The timing signal S_{W1} may represent the total integration period duration for a ROIC pixel associated with row 1 of the imager. It should be appreciated that timing signal S_{W1} is similar to timing signal Sᵢₙₜ₁ of FIG. 10A. However, because FIG. 13A illustrates a dual band context utilizing a ROIC pixel of the type illustrated in FIG. 11, the integration period duration represented by signal S_{W1} may be divided between the two wavelength bands detected. The division may be represented by timing signals S_{1λ1} and S_{1λ2}, where S_{1λ1} represents the integration period for pixels in row 1 of the imager for wavelength band λ1, while S_{1λ2} represents the integration period for pixels in row 1 of the imager for wavelength band λ2. Signals S_{1λ1} and S_{1λ2} may be achieved by toggling in any suitable manner back and forth between the integration capacitors illustrated in FIG. 11 during the integration period S_{W1}. Similar operation with respect to pixels in row 2 of a dual band imager is illustrated by the signals S_{W2}, S_{2λ1}, and S_{2λ2}. The signal S_{W2} may represent the total integration period duration for a ROIC pixel associated with row 2 of the imager. S_{2λ1} represents the integration period for pixels in row 2 of the imager for wavelength band λ1. S_{2λ2} represents the integration period for pixels in row 2 of the imager for wavelength band λ2. The integration period duration for row 480 of the imager is also illustrated in FIG. 13A, though the individual integration periods for the two wavelength bands are not shown for that row, for simplicity.

Read out of the pixels may be performed at the times illustrated by corresponding read out periods S_{R01}, S_{R029}, . . . S_{R0480}. In some embodiments, the read out periods may be broken into, or may comprise, two separate read out signals, with one corresponding to each of the wavelength bands detected for a given row of the imager.

FIG. 13B illustrates a non-limiting example of the same signals as those from FIG. 13A only in ripple mode, rather than snapshot mode.

While various examples have been described with respect to provision of different integration period durations to different rows of an imaging array, it should be appreciated that alternatives are possible. For example, alternatives to both the circuitry and methodology described above for providing different integration period durations to different rows of an imaging array are possible. Thus, the foregoing examples are non-limiting and are provided for purposes of illustration.

According to another aspect of the present application, variable gain between rows of an imager may be achieved through use of different integration capacitances for pixels in different rows. As a non-limiting example, reference is again made to FIG. 5. As shown, pixels 500a and 500b each include an integration capacitor, 504a and 504b, respectively. According to an aspect of the present application, the size of capacitor 504a may differ from that of capacitor 504b. In this manner, the gain of pixel 500a may differ from that of pixel 500b. In one non-limiting embodiment, all pixels in the row in which pixel 500a is may include similarly sized integration capacitances. Likewise, all pixels in the row in which pixel 500b is may include similarly sized integration capacitances of a different value than the integration capacitances of the pixels in the row including pixel 500a. Thus, variability between rows may be provided, irrespective of whether the integration period durations differ between the pixels of the different rows. In other words, variable gain may be achieved using integration capacitors of different sizes in the different rows, without the need to alter durations of the integration periods of the rows. In this manner, the timing circuitry may be simplified (e.g., the memory array and multipliers illustrated in FIG. 6 may be absent). However, variable integration period durations between rows of the imager may be combined with variable integration capacitances between the rows of the imager, in one non-limiting embodiment.

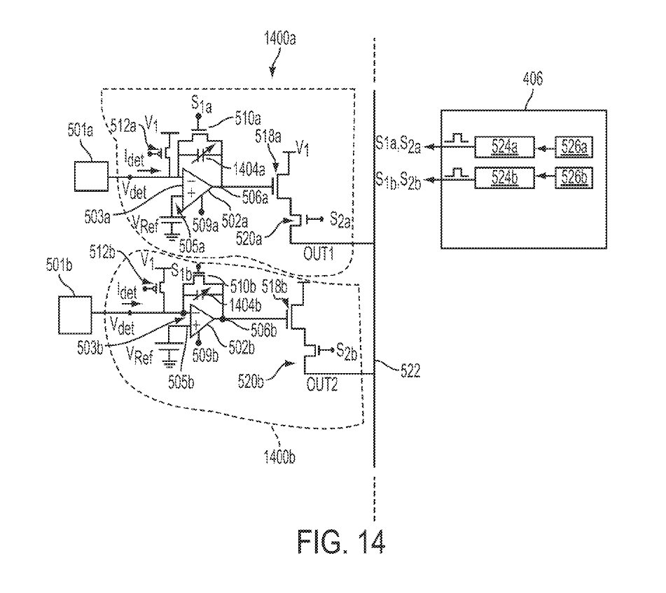

FIG. 14 illustrates a non-limiting alternative embodiment to that of FIG. 5, in which variable capacitances are implemented. As shown, the pixels 1400a and 1400b are substantially similar to pixels 500a and 500b of FIG. 5. However, the fixed capacitors 504a and 504b of pixels 500a and 500b are replaced in pixels 1400a and 1400b by variable capacitors 1404a and 1404b, respectively. In this non-limiting embodiment, the integration capacitances of pixels within a given row may be varied as desired. Thus, if operating conditions of an imager change (e.g., if the temperature of a scene to be imaged changes), the capacitance values of the integration capacitors 1404a and 1404b may be altered accordingly to provide suitable gain for the respective pixels. In this manner, a suitable difference in integration capacitances between rows of the imager may be maintained despite changes in operating conditions of the imager. Thus, suitable compensation for intrinsic differences in the intensity of light received by different rows of the imager may be achieved.

According to another aspect of the present application, variable gain between rows of an imager may be provided via the column circuitry connecting pixels of different rows. As a non-limiting example, a column buffer interconnecting pixels from different rows of an imager may include an amplifier. The gain of the amplifier may be varied when receiving and processing signals from pixels of different rows, thus effectively creating a variable gain between pixels of different rows. In this manner, differences in intensity of radiation received by different rows of the imager may be compensated for, as previously explained herein.

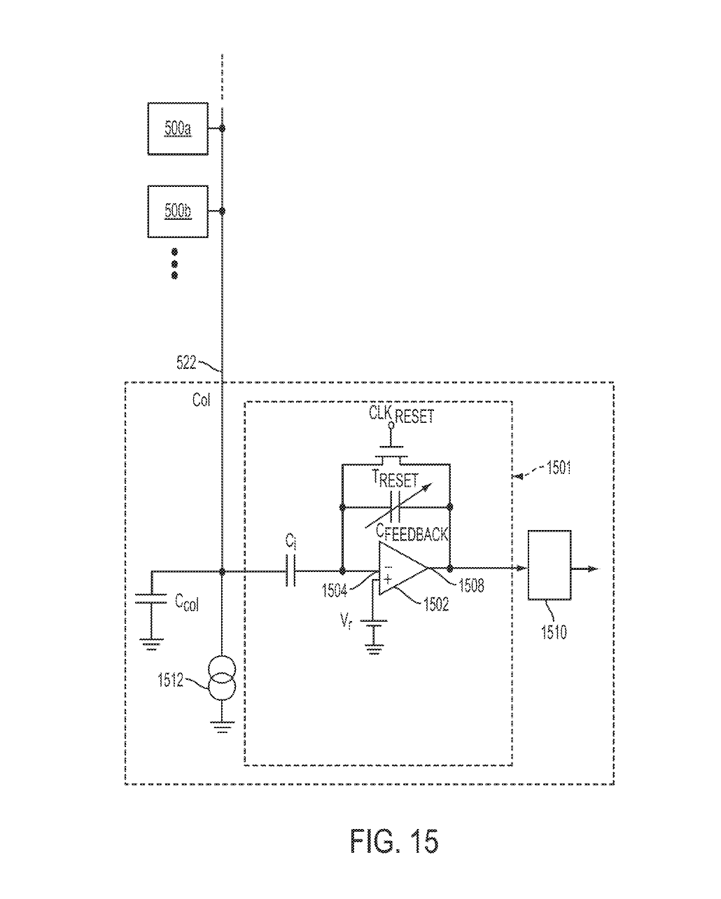

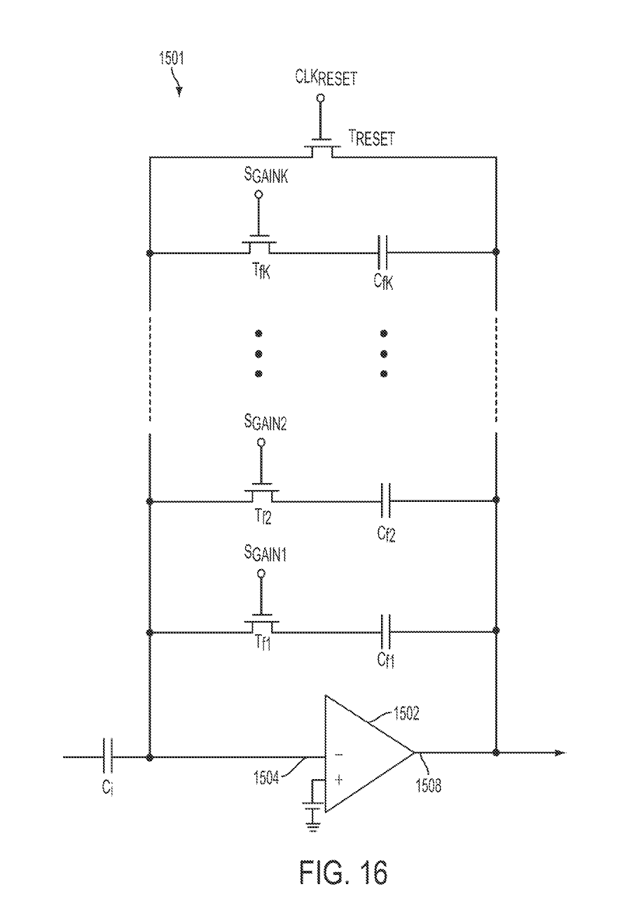

A non-limiting example is illustrated with respect to FIGS. 15 and 16. Referring first to FIG. 15, a non-limiting example of column buffer circuitry suitable for interconnecting rows of an imaging array and providing variable gain between the rows of the imaging array is illustrated. As shown, a column buffer 1500 is coupled to multiple ROIC pixels 500a and 500b, previously described in connection with FIG. 5, via a column bus 522. While pixels 500a and 500b are illustrated, it should be appreciated that other types of pixels may be used. Moreover, the number of pixels coupled to the column buffer 1500 is not limiting.

In the non-limiting example shown, buffer 1500 comprises an amplifier block 1501, itself comprising an amplifier (or gain stage) 1502, an input capacitor Cᵢ, a feedback capacitor C_{feedback}, and a reset transistor Tᵣₑₛₑₜ. The amplifier 1502 has an inverting input terminal 1504, a non-inverting input terminal 1506 (which may be coupled to receive a reference voltage Vᵣ), and an output terminal 1508. The output of the amplifier block 1501 may optionally be coupled to circuitry 1510, which may be, for example, a sample and hold circuit or any other suitable type of circuitry. The reset clock CLKᵣₑₛₑₜ may control operation of the reset transistor Tᵣₑₛₑₜ, to selectively short circuit the output terminal 1508 of amplifier 1502 to the input terminal 1504 of amplifier 1502. The buffer 1500 may optionally include further circuitry such as a current source 1512. The column bus 522 may have an associated capacitance C_{col}, as illustrated.

The gain of the buffer 1500 may be varied suitably to provide inter-row variable gain, i.e., differences in gain applied to pixels from different rows of an imaging array. For instance, the gain of the amplifier 1502 may assume a first value when the buffer 1500 receives and processes the output signal of pixel 500a and then may be varied to assume a second value when the buffer receives the output signal of pixel 500b. Assuming pixels 500a and 500b are associated with different rows of an imaging array, operating the buffer 1500 as just described results in application of different gains to pixels of different rows of the imaging array.

The gain of a column buffer may be varied in any suitable manner to realize inter-row variable gain, as the aspects described herein relating to varying the gain of a column buffer (or other column circuitry configured to receive and process signals from pixels of different rows of an imager) are not limited to the manner in which the gain is varied. However, a non-limiting example of a suitable manner for varying (or altering) the gain of a column buffer is now described with respect to FIG. 15.

The gain of the amplifier block 1501 may be given by −Cᵢ/C_{feedback}, such that the amplifier block 1501 may effectively operate as a charge amplifier. Thus, by varying the capacitance value of C_{feedback}, the gain of the buffer 1500 may be varied. Accordingly, C_{feedback} may be a variable capacitor according to a non-limiting embodiment. The capacitance value may be varied between when an output signal of a ROIC pixel associated with one row of an imager is received and when an output signal of a ROIC pixel associated with a different row of the imager is received. Also, the gain may be varied in response to environmental factors, such as lighting conditions (e.g., low light v. bright light scenarios, changes in temperature, differences in received light intensity owing to blackbody radiation effects for a single temperature, etc.), or for any other reason.

FIG. 16 illustrates one non-limiting example of a manner of implementing C_{feedback} as a variable capacitor. As shown, C_{feedback} may be implemented with k capacitors (C_{f1}, C_{f2}, . . . , C_{fk}) arranged in parallel between the input terminal 1504 and output terminal 1508 of amplifier 1502. Each of the feedback capacitors C_{f1}, C_{f2}, . . . , C_{fk} may be coupled to the input terminal 1504 of the amplifier 1502 by a respective switch, T_{f1}, T_{f2}, . . . , T_{fk}. Alternatively, the switches T_{f1}, T_{f2}, . . . , Tₜₖ may be coupled between the respective feedback capacitor and the output terminal 1508 of amplifier 1502. The total feedback capacitance may thus be varied by turning on/off appropriate switches T_{f1}, T_{f2}, . . . , Tₜₖ using their respective control signals S_{gain1}, S_{gain2}, . . . , S_{gaink}. In the non-limiting example of FIG. 16, k different values of capacitance can be switched into or out of the feedback path, providing up to 2^{k} different values of gain for the column buffer.

As a non-limiting example of the operation of the circuitry in FIG. 16, the gain of the illustrated column buffer may be set to a first value by selection of a first combination of feedback capacitors C_{f1}, C_{f2}, . . . , C_{fk}. An output signal from pixel 500a may then be received and processed. The gain of the column buffer may then be adjusted to assume a second value different from the first value by selection of a different combination of the feedback capacitors C_{f1}, C_{f2}, . . . , C_{fk}. An output signal of pixel 500b may then be received and processed. Thus, a different gain may be applied to the output of pixel 500b than was applied to the output of pixel 500a. This manner of operation may continue for as many rows or groups of rows of the imaging array as is desirable. Thus, different gains may be applied to as many rows or groups of rows as is desirable.

According to one embodiment, a sufficient number of feedback capacitors may be provided to allow for as many different values of gain as there are rows of an imaging array with which the column buffer 1500 is to be implemented. For example, if a ROIC including the column buffer 1500 is to be implemented in a 480 row imager, then the number of feedback capacitors illustrated in FIG. 16 may take a value sufficient to allow for generation of up to 480 different gain values. In this manner, the buffer may potentially apply a different gain value to output signals received from pixels of each of the 480 rows of the imager. However, it should be appreciated that the aspects described herein relating to varying the gain of column circuitry (e.g., varying the gain of an amplifier of a column buffer) to provide inter-row variable gain are not limited to being able to provide any particular number of different gain values.

While FIGS. 15 and 16 illustrate examples of suitable column circuitry for providing inter-row variable gain, it should be appreciated that alternative circuitry and alternative methods of providing inter-row variable gain using column circuitry are possible. Thus, FIGS. 15 and 16 and the corresponding description are non-limiting examples.

In some embodiments, it may desirable to minimize the amount of data (e.g., calibration values) to be stored by a memory of the ROIC, or to eliminate entirely the need for any such memory. In this manner, the ROIC design may be simplified in some embodiments. A non-limiting example of an embodiment in which memory usage is reduced or eliminated is now described.

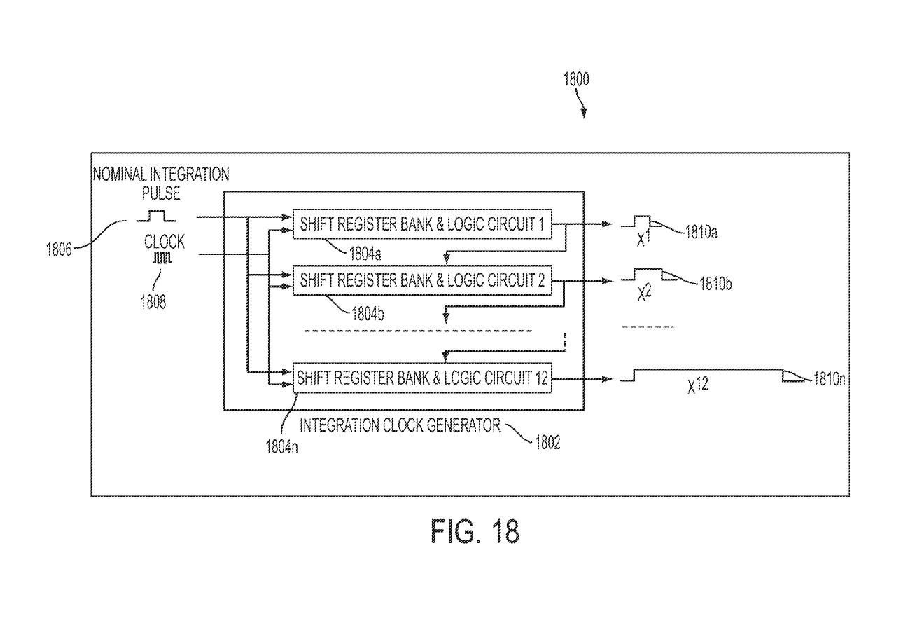

Referring to FIG. 18, a suitable circuit for generating integration signals according to a non-limiting embodiment is illustrated. As shown, the circuit 1800 includes an integration clock generator 1802 comprising a plurality of shift register bank and logic circuits 1804a, 1804b . . . 1804n. For purposes of illustration, n=12 in this non-limiting embodiment, but other values of n may also be used. The shift register bank and logic circuits receive a nominal integration pulse 1806, as well as a clock signal 1808. Each shift register bank and logic circuit then outputs an adjusted integration pulse 1810a, 1810b . . . 1810n, for the corresponding row/rows of the ROIC, which may be analogous as the width adjusted pulse of FIG. 6.

Comparing the illustrated embodiment to that of FIG. 6, it is seen that the embodiment of FIG. 18 does not require the storage of the calibration data of FIG. 6, and thus reduces the memory requirement (even eliminating the need for the memory in some embodiments). Thus, the configuration of FIG. 18 may be simpler in some embodiments.

Because the circuit 1800 does not store calibration data relating to different operating temperatures, the manner of operation of the circuit may differ from that of FIG. 6. For example, the ROIC implementing the circuit 1800 may be programmed or calibrated to operate assuming a desired operating temperature (e.g., 300 K). Thus, the need to store calibration data relating to different temperatures may be obviated. Furthermore, a different scheme may be used to accommodate temperature deviations from the assumed value than that relating to the operation of FIG. 6.

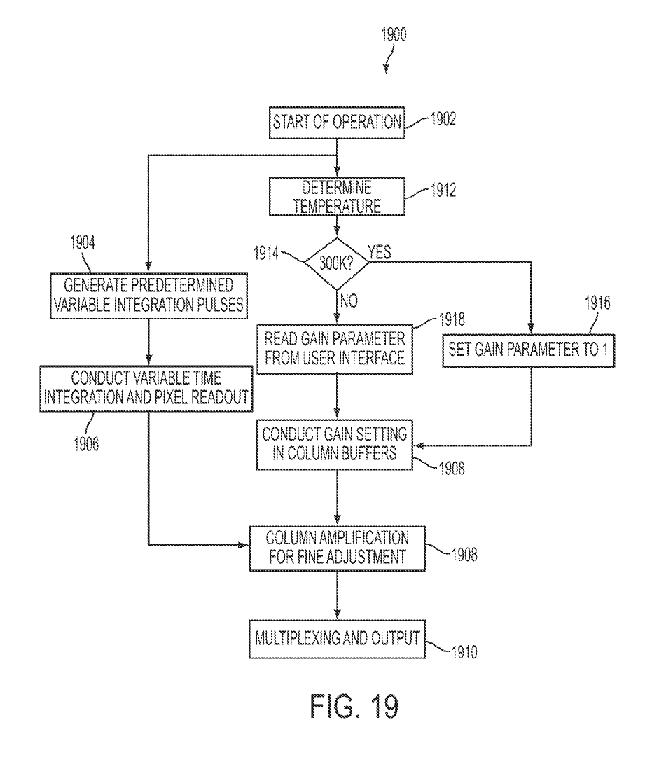

One manner of operating a ROIC utilizing a circuit of the type illustrated in FIG. 18 is to calibrate the device assuming a single temperature (e.g., 300 k). If deviations from this temperature are detected, the gain of any given row(s) may be adjusted, for example by adjusting the gain of the column buffer associated with that row(s). A non-limiting example is described with respect to FIG. 19.

FIG. 19 is a flowchart illustrating a non-limiting embodiment of operation of a ROIC including the circuit 1800 of FIG. 18, and assuming that the circuit has been calibrated based on a single temperature (e.g., 300K in this non-limiting example). The method 1900 begins at 1902 with a branching option. If temperature deviations are not to be accounted for, the method may proceed to 1904 at which predetermined variable integration pulses may be generated (e.g., assuming the temperature to which the ROIC was initially calibrated). Variable time integration and pixel readout may then occur at 1906. Column amplification may be performed at 1908, for example by varying the gain of the column amplifiers associated with a row or rows. Multiplexing and output of signals from the rows may then occur at 1910.

If temperature deviations are to be accounted for, then after the start of the operation at 1902 the temperature may be determined at 1912. If the temperature is determined to match the temperature to which the system was calibrated (i.e., 300K in this non-limiting example), then a gain parameter may be set to one (or other suitable value) at 1916 to cause the gain settings of the column buffers to correspond to the pre-calibrated temperature operation. The gain of the column buffers may then be suitably set at 1918 (e.g., during the time interval between readout of adjacent rows, or at any other suitable time). Column amplification may occur at 1908 as previously described, followed by multiplexing and output of signals at 1910, as previously described.

If, at 1914, it is determined that the temperature differs from that to which the system was calibrated, the method may proceed to 1918, where the gain parameters for the column buffers may be read from a user interface or other suitable input. In this non-limiting embodiment, a user may be able to input gain settings (e.g., manually) based on the detected temperature. The gain settings may then be used to set the gains of the column amplifiers at 1918, after which the method may proceed to 1908 and 1910 as previously described.

Thus, it should be appreciated that the method 1900 of FIG. 19 represents an alternative manner of operation to that illustrated in FIG. 7 to account for the system not storing calibration data for multiple temperatures.

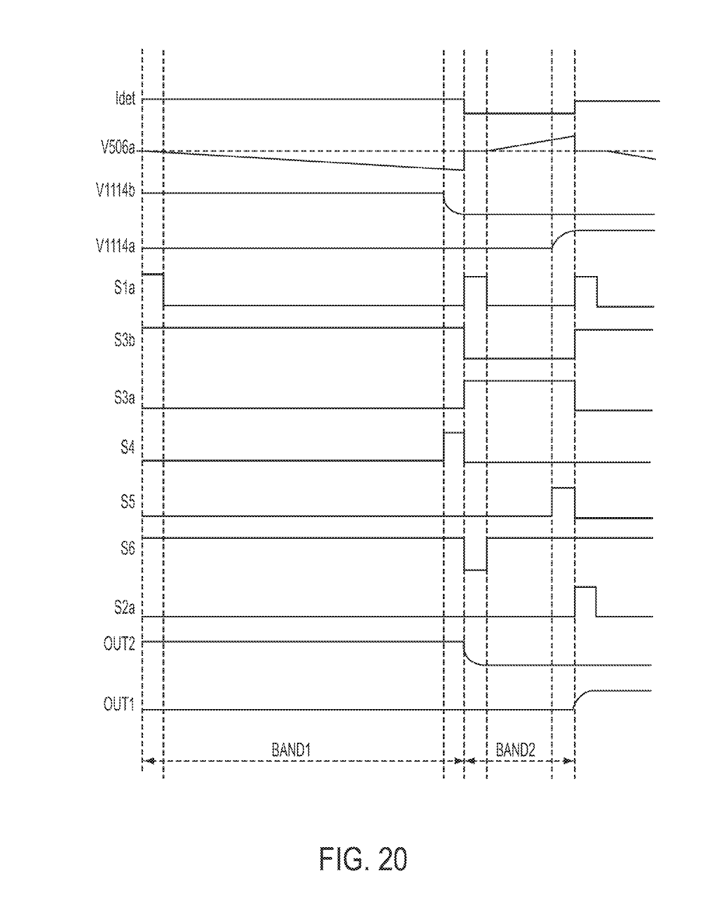

FIGS. 20, 21A-21B, and 22A-22B illustrate timing diagrams of operation of systems which may utilize the circuit 1800 of FIG. 18. FIG. 20 illustrates the timing signal traces corresponding to operation of a ROIC of the type illustrated in FIG. 11 in accordance with the circuit 1800 of FIG. 18. A sequential integration mode of two different wavelength bands (identified as Band 1 and Band 2) is illustrated. The signal trace identifications correspond to those of FIG. 12, with the difference being that absolute voltage/current values are not illustrated in FIG. 20.

Further explanation relates to a system configuration in which ROIC rows are grouped together in terms of the integration pulses which they generate. For example, groups of forty rows may produce similar or identical integration pulses. By creating groups of rows, the system timing may be simplified compared to if integration pulses of different duration were generated for each row of the ROIC. In the non-limiting example that follows, it is assumed that the ROIC rows are grouped into groups of forty, such that a 480 row imager may include twelve groups. It should be appreciated that other groupings may be created, and that in some embodiments each row has its own respective integration pulse duration.

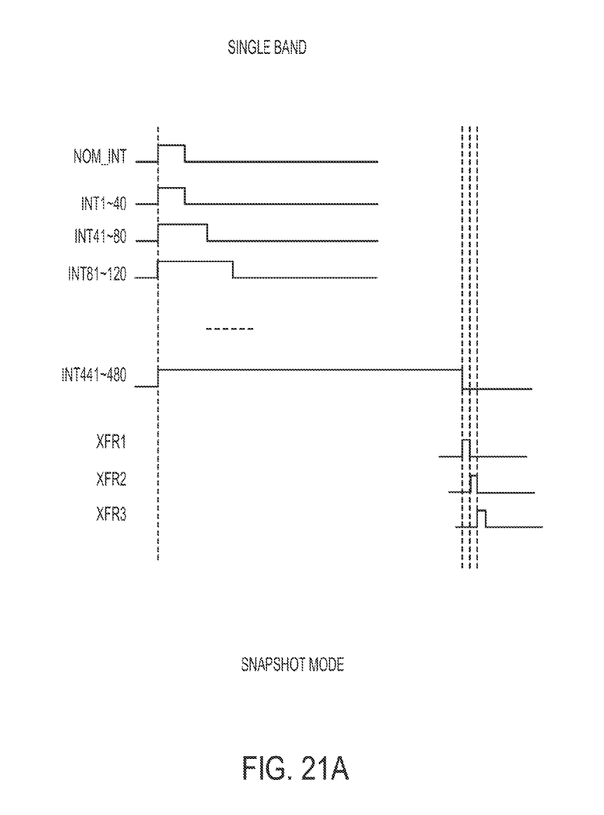

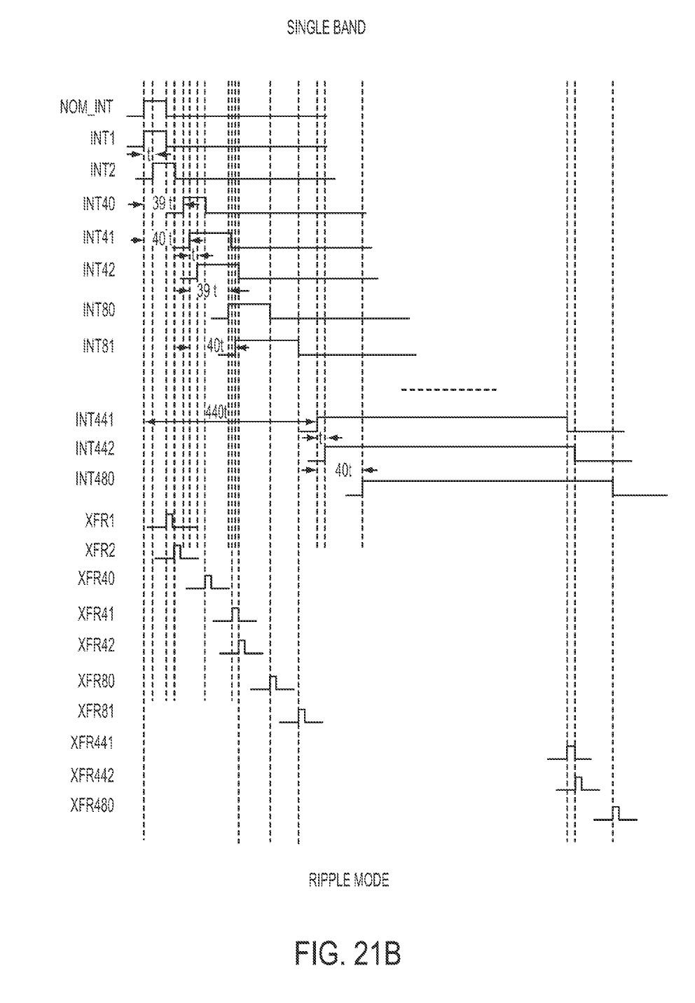

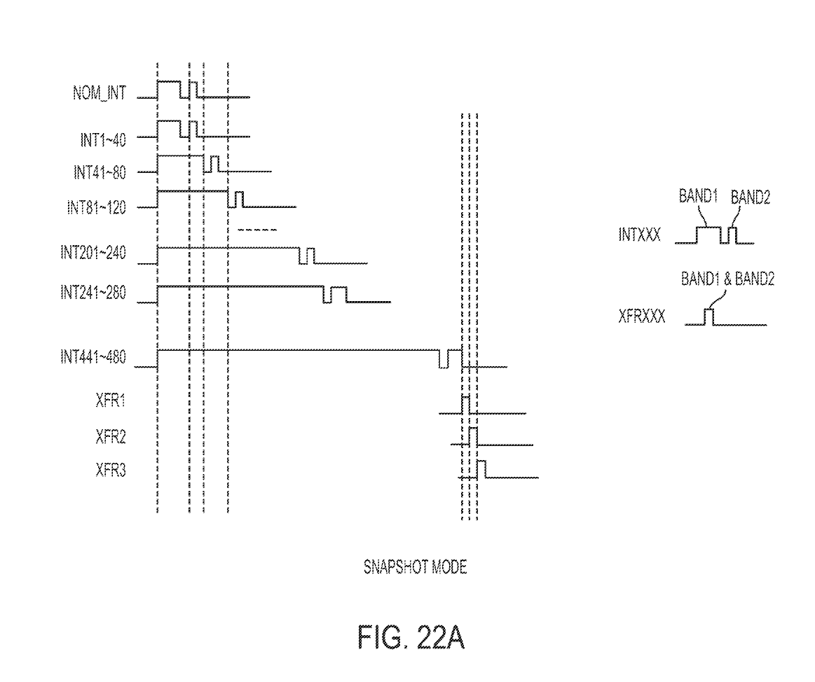

FIG. 21A illustrates snapshot mode operation for a single wavelength band. As shown, the nominal integration pulse duration is represented at the top of the figure. The first grouping of forty rows may have an integration pulse duration equal to the nominal integration pulse. The integration pulse for subsequent row groups may be increased as shown (e.g., linearly or otherwise), for example in accordance with the method of FIG. 19. The readout signals XFR1 (for group 1), XFR2 (for group 2), XFR3 (for group 3) are shown for three of the row groups.

FIG. 21B illustrates ripple mode operation assuming the same circuit configuration as that assumed for the operation illustrated in FIG. 21A. As with FIG. 21A, the timing of FIG. 21B relates to operation on a single wavelength band. The nominal integration pulse (NOM_INT) is illustrated, as well as the integration pulses for various rows of the imager (i.e., INT1 for row 1, INT 2 for row 2, etc.). The readout signals for some of the rows (i.e., XFR1 for row 1, XFR2 for row 2, etc.) are also shown.

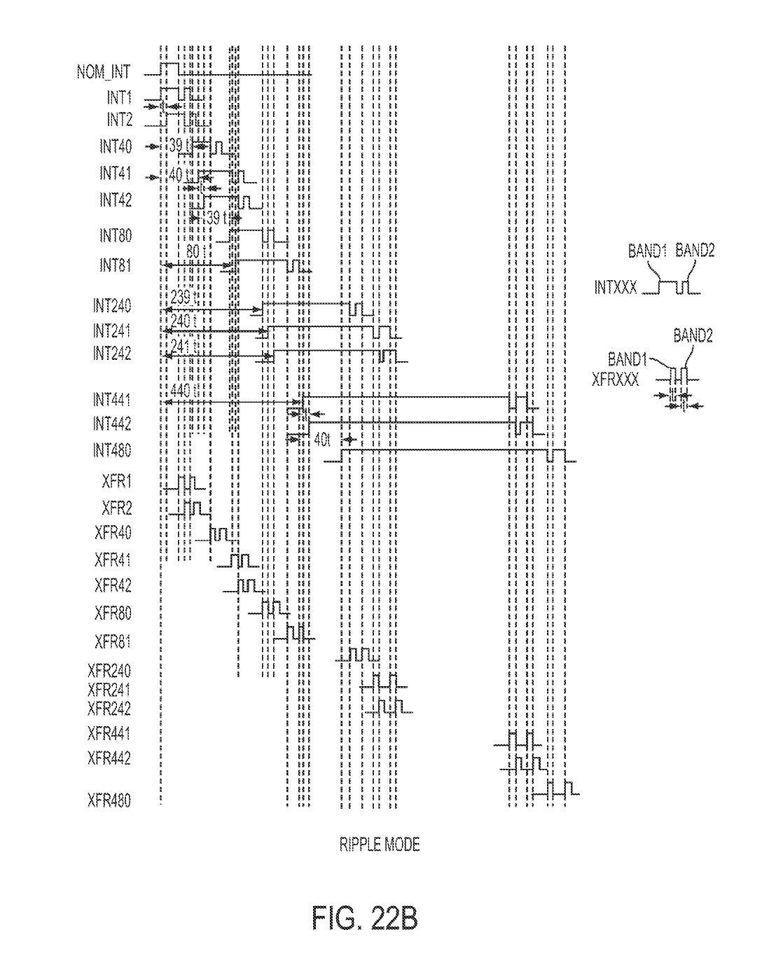

FIGS. 22A-22B illustrate, respectively, snapshot mode operation and ripple mode operation for a circuit performing dual band operation (as opposed to the single band operation illustrated in FIGS. 21A and 21B) in a sequential fashion (i.e., integration of band 1 and then integration of band 2), according to an embodiment of the present application. The nominal integration pulse is represented by “NOM_INT”. The integration pulses for various rows are illustrated, and represented by INTXXX, where XXX is the row number. Similarly, the read out pulses are shown for various rows, and are represented by XFRXXX where XXX is again the row number. It should be appreciated that the timing illustrated in FIGS. 22A-22B is illustrative, and that other timing schemes are also possible.

A non-limiting example of the respective durations of some of the pulses illustrated in FIG. 22B is now provided. Assuming that the two wavelength bands are MWIR and LWIR, the nominal integration time for the MWIR band may be Tint_m. The nominal integration time for the LWIR band may be Tin_l. Also assuming the imager includes 480 rows organized in groups (or blocks) of forty rows for timing purposes, the respective timing durations may be given by the following Table 1.

TABLE 1
Respective Timing Signals for Dual Band Operation

| Rows | Band 1 (MWIR) | Band 2 (LWIR) |
|---|---|---|
| Block 1 (rows 1-40) | 1 × Tint-m | 1 × Tint_1 |
| Block 2 (rows 41-80) | 2 × Tint-m | 1 × Tint_1 |
| Block 3 (rows 81-120) | 3 × Tint-m | 1 × Tint_1 |
| Block 4 (rows 121-160) | 4 × Tint-m | 1 × Tint_1 |
| Block 5 (rows 161-200) | 5 × Tint-m | 1 × Tint_1 |
| Block 6 (rows 201-240) | 6 × Tint-m | 1 × Tint_1 |
| Block 7 (rows 241-280) | 7 × Tint-m | 2 × Tint_1 |
| Block 8 (rows 281-320) | 8 × Tint-m | 2 × Tint_1 |
| Block 9 (rows 321-360) | 9 × Tint-m | 2 × Tint_1 |
| Block 10 (rows 361-400) | 10 × Tint-m | 2 × Tint_1 |
| Block 11 (rows 401-440) | 11 × Tint-m | 2 × Tint_1 |
| Block 12 (rows 441-480) | 12 × Tint-m | 2 × Tint_1 |

While various non-limiting embodiments and examples have been described in the foregoing, it should be appreciated that the various aspects are not limited to those examples provided. For example, imagers utilizing different types of pixels (e.g., direct injection pixels, multiband pixels, etc.) may utilize one or more aspects of the present application. CTIA technology represents a non-limiting example. Furthermore, for those aspects in which different integration period durations are provided to different rows of an imager, provision of such different times may be accomplished in any manner. According to one embodiment, a single band imager may utilize one or more aspects of the present application. Alternatively, a dual band imager may be provided which detects wave lengths in two different bands and also provides variable gain between rows of the imager. According to another non-limiting embodiment, a dual band hyperspectral imager may be provided, which provides for variable gain between rows of the imager. Other implementations and applications are possible.

Moreover, various benefits may be realized by application of one or more of the aspects described, though it should be appreciated that not all aspects necessarily provide each benefit. For example, improvements in image quality across multiple wavelength bands may be provided. Shadows in images owing to intensity differences of detected radiation may be minimized or eliminated. Flexibility in adjusting the gain of an imager to account for various environmental conditions (e.g., various temperatures, various changes in temperature, various lighting conditions (e.g., day, dusk, night, etc.)) may also be realized. The dynamic range of an imager may be maximized. For instance, by varying the gain across the rows of an imaging array the maximum and minimum flux levels may be made to correspond to the maximum and minimum output signal of each row. In this manner, the signal to noise ratio (SNR) and other performance attributes of a focal plane array may be improved. In some embodiments, utilizing different integration times for pixels in different rows, or varying the gain of a column buffer as described herein may optimize the signal to noise ratio of an imager. Other benefits may also be realized.

Additionally, it should be appreciated that the aspects described herein relating to provision of inter-row variable gain may be implemented in combination with known techniques for providing variable gain between columns of an imager. In this manner, gain may be varied both between rows of the imager and between columns of the imager. Inter-row variable gain together with variable gain between columns may provide great flexibility in some contexts to address environmental conditions, operating conditions, or any other aspects of the performance of an imager.

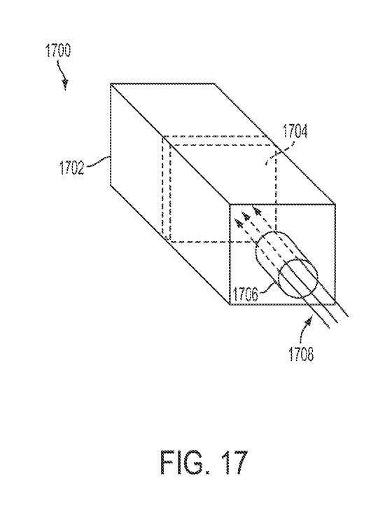

The various aspects of the invention described herein may be used in various devices, and are not limited to use in any particular types of devices. According to one embodiment, ROICs and methods according to any of the aspects described herein may be used to form and/or operate at least part of an imaging device (e.g., a camera). For example, referring to FIG. 17, an imaging device 1700 (e.g., a camera) may include a housing 1702, an imaging array and ROIC 1704 disposed within the housing (for example, on two separate but coupled substrates, or on a single substrate), and optics 1706. The ROIC may be any of the types described herein. The optics may include any suitable optics (e.g., collimation optics, one or more lenses, one or more filters, etc.) for collecting and focusing incident radiation 1708 on the imaging array. The imaging device may be used in any desired application, such as for daytime imaging, night vision, mixed day and night imagers, commercial and/or industrial imagers, or any other application.

One or more aspects and embodiments of the present application involving the performance of methods may utilize program instructions executable by a device (e.g., a computer, a processor, or other device) to perform, or control performance of, the methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments discussed above. The computer readable medium or media can be transportable, such that the program or programs stored thereon can be loaded onto one or more different computers or other processors to implement various ones of the aspects discussed above. In some embodiments, computer readable media may be non-transitory media.

Having thus described several aspects and embodiments of the technology, it is to be appreciated that various alterations, modifications, and improvements will readily occur to those skilled in the art. Such alterations, modifications, and improvements are intended to be within the spirit and scope of the technology. Accordingly, the foregoing description and drawings provide non-limiting examples only.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A readout integrated circuit (ROIC), comprising:
a memory configured to store, for each of a plurality of temperatures, a plurality of integration period scaling factors including a first integration period scaling factor corresponding to at least one first row of an array of imaging pixels and a second integration period scaling factor corresponding to at least one second row of the array of imaging pixels;
a plurality of multipliers, each multiplier of the plurality of multipliers configured to:
receive a nominal integration period value;
receive one of the plurality of integration period scaling factors; and
scale the nominal integration period value by the one of the plurality of integration period scaling factors to produce a corresponding scaled integration period value; and
a plurality of pulse generators including one pulse generator corresponding to each row of the array of imaging pixels,
wherein each of the plurality of pulse generators is configured to receive a scaled integration period value from a multiplier of the plurality of multipliers and generate one or more timing signals based on the received scaled integration period value, wherein the one or more timing signals control, at least in part, a duration of an integration period of imaging pixels in a corresponding row of the array of imaging pixels.

2. The ROIC of claim 1, coupled to the array of imaging pixels to form an imager, the array of imaging pixels comprising a plurality of rows of imaging pixels including the at least one first row and the at least one second row.

3. The ROIC of claim 1, wherein each multiplier of the plurality of multipliers is configured to receive a same nominal integration period value.

4. The ROIC of claim 1, wherein the plurality of multipliers comprises one multiplier corresponding to each pulse generator of the plurality of pulse generators.

5. The ROIC of claim 1, wherein the memory is further configured to store, for each of the plurality of temperatures, data indicative of which row or group of rows of the array of imaging pixels corresponds to a largest integration period scaling factor of the plurality of integration period scaling factors.

6. The ROIC of claim 1, wherein the memory comprises a lookup table comprising a plurality of columns and a plurality of rows, wherein the plurality of columns of the lookup table comprises at least one column corresponding to each temperature of the plurality of temperatures, and wherein each column of the lookup table corresponding to a temperature of the plurality of temperatures comprises at least one row corresponding to each row of imaging pixels of the array of imaging pixels.

7. The ROIC of claim 6, wherein the at least one row corresponding to each row of imaging pixels of the array of imaging pixels is configured to store an integration period scaling factor.

8. The ROIC of claim 1, wherein the first row of the array of imaging pixels comprises at least three linearly arranged pixels coupled to respective column lines.

9. A readout integrated circuit (ROIC), comprising:
circuitry configured to provide an imaging array having multiple rows of imaging pixels with different gains for at least two rows of the multiple rows.

10. The ROIC of claim 9, wherein the circuitry configured to provide the imaging array with different gains for at least two rows comprises circuitry configured to implement a first integration period duration for a first imaging pixel of a first row of the multiple rows and a second integration period duration for a first imaging pixel of a second row of the multiple rows, the first integration period duration differing from the second integration period duration.

11. The ROIC of claim 10, wherein the circuitry configured to implement a first integration period duration for a first imaging pixel of a first row of the multiple rows and a second integration period duration for a first imaging pixel of a second row of the multiple rows comprises circuitry configured to implement the first integration period duration for all imaging pixels of the first row of the multiple rows and the second integration period duration for all imaging pixels of the second row of the multiple rows.

12. The ROIC of claim 9, wherein the circuitry comprises a memory array configured to store integration period calibration factors.

13. The ROIC of claim 9, wherein the circuitry comprises a first pulse generator and a second pulse generator, wherein the first pulse generator is configured to generate at least one first timing signal to produce a first integration period duration for a first imaging pixel in a first row of the multiple rows and wherein the second pulse generator is configured to generate at least one second timing signal to produce a second integration period duration for a first imaging pixel in a second row of the multiple rows, wherein the first integration period duration differs from the second integration period duration.

14. The ROIC of claim 9, wherein the circuitry comprises a least one capacitive transimpedance amplifier (CTIA) ROIC pixel.

15. The ROIC of claim 14, wherein the circuitry is further configured to process signals from the imaging array corresponding to at least two different wavelength bands of radiation.

16. The ROIC of claim 9, wherein the circuitry is further configured to process signals from the imaging array corresponding to at least two different wavelength bands of radiation.

17. The ROIC of claim 9, wherein the circuitry configured to provide the imaging array with different gains for at least two rows comprises circuitry configured to create different integration capacitances for the at least two rows.

18. The ROIC of claim 17, wherein the circuitry configured to create different integration capacitances for the at least two rows comprises a first integration capacitor corresponding to a first imaging pixel of a first row of the at least two rows and a second integration capacitor corresponding to a first imaging pixel of a second row of the at least two rows, wherein the first integration capacitor has a first capacitance value and the second integration capacitor has a second capacitance value different than the first value.

19. The ROIC of claim 18, wherein the first capacitance value is variable.

20. The ROIC of claim 9, wherein the circuitry configured to provide the imaging array with different gains for at least two rows comprises a column buffer configured to receive an output signal from at least one imaging pixel from a first row of the at least two rows and an output signal from at least one imaging pixel from a second row of the at least two rows, wherein the column buffer comprises an amplifier having a variable gain.

21. The ROIC of claim 20, wherein the amplifier having the variable gain comprises multiple feedback capacitors between an output of the amplifier and an input of the amplifier, and wherein the ROIC is configured to vary a gain value of the amplifier by selection of the multiple feedback capacitors.

22. The ROIC of claim 9, wherein a first row of the at least two rows comprises at least three linearly arranged pixels coupled to respective column lines.

23. The ROIC of claim 9, wherein a first row of the at least two rows comprises a plurality of imaging pixels configured to be addressed via a common clock signal but which are configured to provide respective output signals to respective column circuitry.

24. A method of operating a readout integrated circuit (ROIC), the method comprising:
generating differences in gain between at least two different rows of an imaging array.

25. The method of claim 24, wherein generating differences in gain between at least two different rows of the imaging array comprises applying a first integration period duration to a first imaging pixel of a first row of the imaging array and applying a second integration period duration to a first imaging pixel of a second row of the imaging array, the first integration period duration differing from the second integration period duration.

26. The method of claim 25, wherein applying the first integration period duration to the first imaging pixel of the first row of the imaging array comprises applying the first integration period duration to all imaging pixels of the first row of the imaging array, and wherein applying the second integration period duration to the first imaging pixel of the second row of the imaging array comprises applying the second integration period duration to all imaging pixels of the second row.

27. The method of claim 25, wherein applying the first integration period duration comprises generating timing signals to control integration of the first imaging pixel using an integration period scaling factor from a memory of the ROIC.

28. The method of claim 24, wherein generating differences in gain between at least two different rows of the imaging array comprises integrating photocurrent from a first imaging pixel of a first row of the imaging array on a first integration capacitor having a first capacitance value and integrating photocurrent from a first imaging pixel of a second row of the imaging array on a second integration capacitor having a second capacitance value, the second capacitance value differing from the first capacitance value.

29. The method of claim 24, wherein generating differences in gain between at least two different rows of the imaging array comprises varying a gain of a column buffer amplifier to assume a first gain value when receiving an output signal of a first imaging pixel of a first row of the imaging array and a second gain value when receiving an output signal of a first imaging pixel of a second row of the imaging array, the second gain value differing from the first gain value.

30. The method of claim 29, wherein varying the gain of the column amplifier comprises varying a feedback capacitance value of the column buffer amplifier.

31. A readout integrated circuit (ROIC), comprising:
an integration clock generator configured to produce respective integration signals for at least two rows of an imager, wherein at least a first and second of the respective integration signals have different durations.

32. The ROIC of claim 31, wherein the ROIC does not comprise a memory.

33. The ROIC of claim 32, wherein the ROIC does not store calibration values to be used in creating the different durations.
